(19) United States
(12) Patent Application Publication
(10) Pub. No.: US 2011/0238497 A1
(43) Pub. Date: Sep. 29, 2011

(54) SYSTEMS AND METHODS FOR AN IMPROVED ONLINE TICKET MARKETPLACE

(76) Inventors: JOEL TYLER MILNE, Los Angeles, CA (US); Alison Burnham, Oakville (CA); Larry Martin, Cross River, NY (US); Jason Wang, Irvine, CA (US); Adam Kanner, New York, NY (US)

(21) Appl. No.: 13/071,839

(22) Filed: Mar. 25, 2011

Related U.S. Application Data
(60) Provisional application No. 61/317,694, filed on Mar. 25, 2010.

(51) Int. Cl. G06Q 30/00

(52) U.S. Cl. 705/14.49; 705/26.3

(57) ABSTRACT

The present disclosure is directed to systems and methods for providing an opaque online marketplace and distribution network for items, tickets, tokens, and other goods or services using a dynamic pricing engine and user-specific market price adjustments, and drawing inventory from multiple sources. Under-sold inventory from an inventory source may be monetized, while protecting the brand of the market entities, and consumers may be allowed to purchase items and tickets at a dynamic market value which, in some cases, may be below face value or a default retail price. Furthermore, a market price may be adjusted by a user-specific price adjustment, on an individualized basis, to manage user satisfaction and provide incentives.

### RELATED APPLICATIONS

This present application claims priority to and the benefit of U.S. Provisional Patent Application No. 61/317,694, entitled “System and Method for an Improved Online Ticket Marketplace,” filed Mar. 25, 2010, which is hereby incorporated by reference in its entirety.

### FIELD OF THE INVENTION

The present disclosure relates to systems and methods for providing an improved online marketplace for tickets. In particular, the present disclosure relates to an opaque marketplace providing dynamic pricing and user-specific price adjustments.

### BACKGROUND OF THE INVENTION

Systems for buying and selling items, including everything from concert and sporting event tickets to books, clothing, software, vehicles, or any other item of inventory typically involve systems where all transactional details are visible to purchasers. These details frequently include the identity of the seller.

For example, in order to attend a sporting event, concert, or theatre production, an individual is typically required to purchase a ticket. Before the advent of the Internet, tickets were generally purchased directly from a “box office,” i.e. a business office at the venue hosting the event, or by mail. Tickets for such events may now be purchased “online,” but the market for event tickets is still flawed.

For example, over 50% of overall ticket capacity is “unsold.” Unsold capacity represents a huge loss of revenue for teams and venues. Part of the problem is that there is no effective liquidation channel allowing inventory to be sold at discount and there is no effective way to match ticket price to demand. From the consumer side, problems exist finding tickets to events at prices the consumer is willing to pay. Although a secondary market for tickets is growing, it still remains fragmented and, as a market, is rife with inefficiencies. One problem is that, in the secondary market, teams and venues are unable to openly discount ticket prices due to the negative effect that would have on tickets presold by those teams and venues at face value, and potential harm to goodwill.

Another problem is that vendors may lack sufficient data for dynamically pricing tickets to match demand. The data for being able to provide an offer to purchase a ticket to the right customer, at the right time, for the right price may be complicated and involve purchase information of unrelated goods or services unavailable to the vendor.

The same problems arise in other industries. A retailer cannot sell an item to satisfy early demand at a first price and quickly reduce the price as demand wanes without upsetting early purchasers, or easily locate potential customers based on their similarity to other previous purchasers. Similarly, where inventory or supplies are limited, a manufacturer cannot easily raise prices to take advantage of purchasers willing to spend more. For example, frequently upon release of a new, hot electronic item, supplies quickly sell out to scalpers or resellers, who then sell the item on the secondary market at two or three times the price. Not only do these sales represent potential lost profits for the manufacturer, the secondary market frequently irritates customers, complicates warranties, and creates other legal and practical difficulties.

### BRIEF SUMMARY OF THE INVENTION

A solution to this problem is provided by the systems and methods described below, which provide an opaque online marketplace and distribution network for items, tickets, tokens, and other goods or services using a dynamic pricing engine and user-specific market price adjustments, and drawing inventory from multiple sources. As used herein, “opaque” refers to the property of the system that a buyer does not know (i) the source of the item or ticket being purchased, (e.g. an original provider of inventory or a reseller); (ii) the current market price of the item or ticket; (iii) the exact seat location (in the case of tickets); or (iv) the volume of inventory available. This property allows under-sold inventory to be monetized, while protecting the brand of the inventory providers, and allows consumers to purchase items and tickets at a dynamic market value which, in some cases, may be below face value or a default retail price. Furthermore, a market price may be adjusted by a user-specific price adjustment, on an individualized basis, to manage user satisfaction and provide incentives.

In some embodiments, user information and historical bid information may be aggregated and analyzed to determine potential marketable packages. For example, in one such embodiment, aggregation of data may allow a vendor to identify that customers matching a first set of characteristics are likely to bid on items, tickets or services matching a second set of characteristics, with bids within an identifiable range. Through these correlations, inventory packages, such as groups of tickets, collections of books, or other items may be dynamically created and offered to customers matching the first set of characteristics. For example, if it may be determined that customers who bid on any available courtside tickets for an NBA game within the last few hours prior to a game at a low bid price are highly interested in basketball games but cannot afford tickets without a deep discount, these customers may be identified and offered packages of cheaper tickets for future games. Similarly, if it may be determined that customers who attend at least two preseason NFL football games frequently purchase playoff tickets, package deals of both preseason and postseason tickets may be dynamically created and offered to customers at a bid level that they are likely to accept.

In one aspect, the present disclosure is directed to a method for accepting offer bids with a dynamically-adjusted market price. The method includes receiving, by a first computing device, an offer from a user to purchase at least one item, the offer specifying a first offer price. The method also includes adjusting, by a dynamic pricing engine executing on the first computing device, a market price for the at least one item using a user-specific price adjustment. The method further includes determining, by the dynamic pricing engine, that the adjusted market price is less than or equal to the first offer price. The method also includes accepting the offer to purchase the item, responsive to the determination.

In some embodiments of the method, the at least one item is a seating ticket for an event. In other embodiments of the method, the market price corresponds to a default retail price or face value price for the at least one item set by a provider of the at least one item.

In one embodiment, the method includes adjusting the market price responsive to one or more characteristics of the user. In another embodiment, the method includes adjusting the market price responsive to an offer history of the user.

In some embodiments, the method includes decreasing the market price by a first predetermined value, responsive to identifying the user as a new user. In other embodiments, the method includes decreasing the market price by a second predetermined value, responsive to identifying the user as a returning user and determining the user has not placed an offer bid within a first predetermined time period. In still other embodiments, the method includes decreasing the market price by a third predetermined value, responsive to identifying the user as matching an advertising target criteria for the at least one item; and further comprising providing to the user an offer to purchase a second item corresponding to the advertising target criteria. In yet still other embodiments, the method includes decreasing the market price by a fourth predetermined value, responsive to determining the user has placed a number of bids for the at least one item within a second predetermined time period, wherein at least a first predetermined percentage of the number of bids have been declined by the dynamic pricing engine.

In one embodiment, the method includes increasing the market price by a fifth predetermined value, responsive to determining the user has placed a number of bids for the at least one item within a third predetermined time period, wherein at least a second predetermined percentage of the number of bids have been accepted by the first computing device.

In another aspect, the present disclosure is directed to a system for accepting offer bids with a dynamically-adjusted market price. The system includes a first computing device, configured to receive an offer from a user to purchase at least one item, the offer specifying a first offer price. The system further includes a dynamic pricing engine executing on the first computing device, configured to adjust a market price for the at least one item using a user-specific price adjustment; and determine that the adjusted market price is less than or equal to the first offer price. The system is further configured to accept the offer to purchase the item, responsive to the determination.

In some embodiments of the system, the at least one item is a seating ticket for an event. In other embodiments, the market price corresponds to a default retail price or face value price for the at least one item set by a provider of the at least one item.

In one embodiment, the dynamic pricing engine is further configured to adjust the market price responsive to one or more characteristics of the user. In another embodiment, the dynamic pricing engine is further configured to adjust the market price responsive to an offer history of the user.

In some embodiments, the dynamic pricing engine is further configured to decrease the market price by a first predetermined value, responsive to identifying the user as a new user. In other embodiments, the dynamic pricing engine is further configured to decrease the market price by a second predetermined value, responsive to identifying the user as a returning user and determining the user has not placed an offer bid within a first predetermined time period. In still other embodiments, the dynamic pricing engine is further configured to decrease the market price by a third predetermined value, responsive to identifying the user as matching an advertising target criteria for the at least one item; and further comprising providing to the user an offer to purchase a second item corresponding to the advertising target criteria. In still yet other embodiments, the dynamic pricing engine is further configured to decrease the market price by a fourth predetermined value, responsive to determining the user has placed a number of bids for the at least one item within a second predetermined time period, wherein at least a first predetermined percentage of the number of bids have been declined by the dynamic pricing engine.

In one embodiment, the dynamic pricing engine is further configured to increase the market price by a fifth predetermined value, responsive to determining the user has placed a number of bids for the at least one item within a third predetermined time period, wherein at least a second predetermined percentage of the number of bids have been accepted by the first computing device.

The details of various embodiments of the invention are set forth in the accompanying drawings and the description below.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising local machines in communication with remote machines;

FIGS. 1B-1C are block diagrams depicting embodiments of computers useful in connection with the methods and systems described herein;

FIG. 2A is a block diagram of an embodiment of a system providing an opaque online marketplace;

FIG. 2B is a block diagram of an embodiment of a server providing an opaque online marketplace with dynamic pricing;

FIG. 2C is a flow chart of an embodiment of an opaque online marketplace with dynamic pricing;

FIG. 3A is a flow chart of an embodiment of a method for accepting offer bids with a dynamically adjusted market price in an opaque marketplace;

FIG. 3B is a block diagram of an abstraction of a system for dynamically adjusting market price;

FIG. 3C is a flow chart of an embodiment of a method of adjusting a market price by a user specific price adjustment; and

FIGS. 4-26 are screenshots of embodiments of an improved online marketplace.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for providing an improved online marketplace; and
Section C describes exemplary embodiments of an improved online marketplace.

### A: Network and Computing Environment

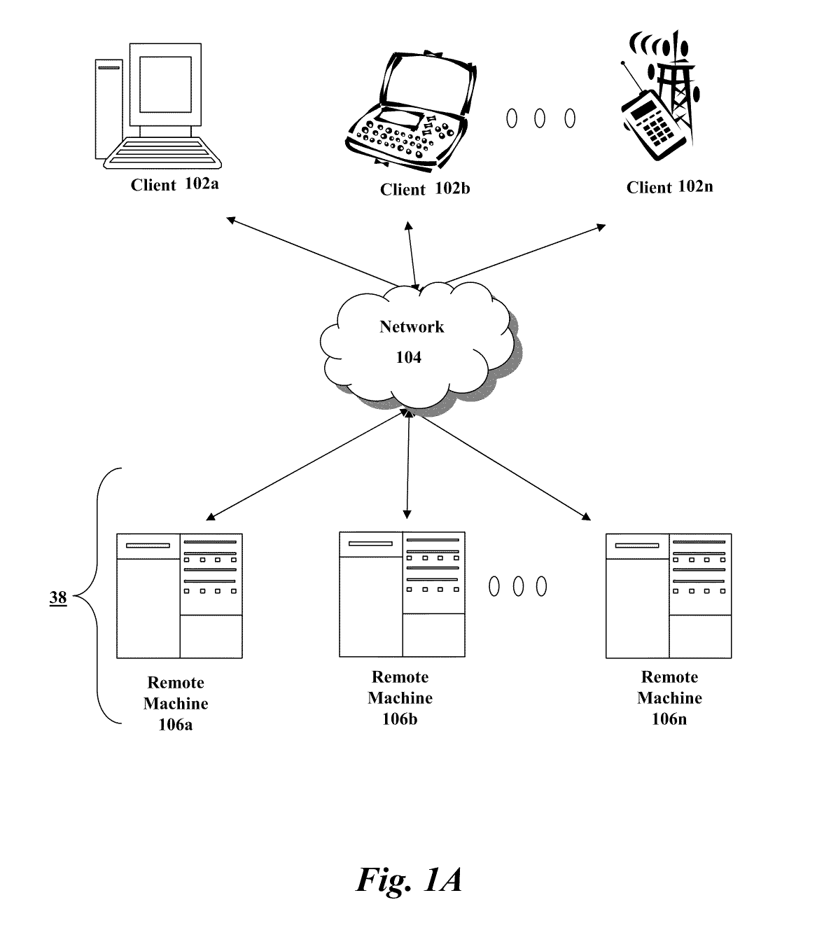

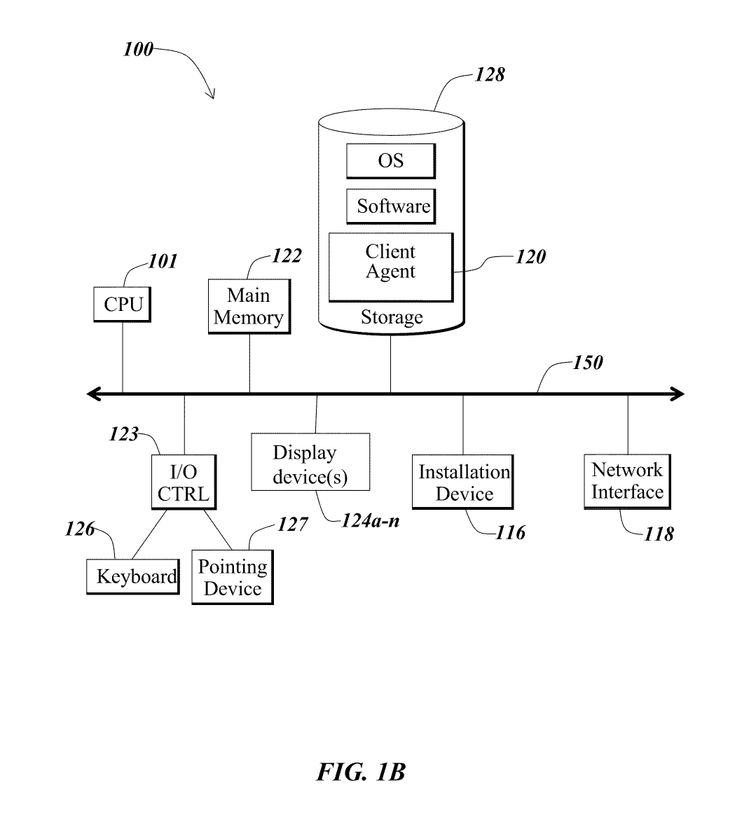

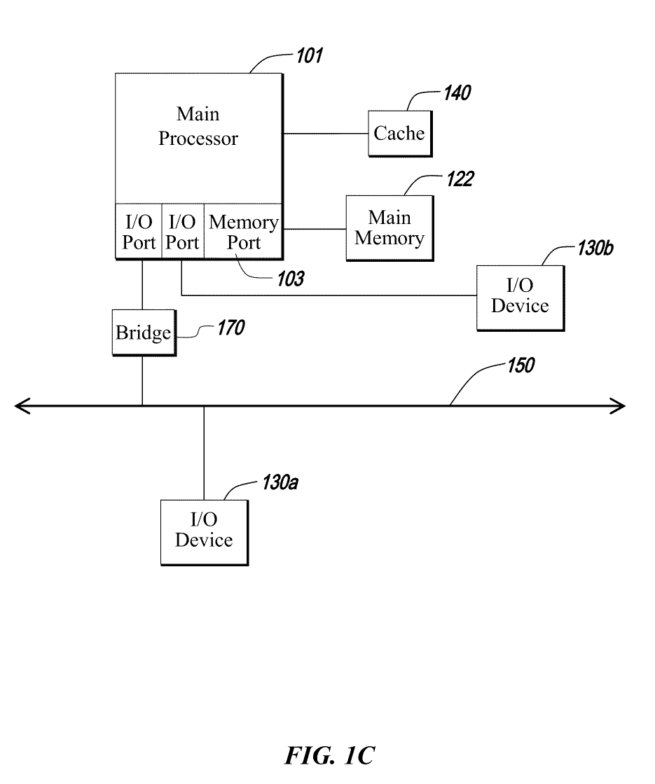

Referring now to FIG. 1A, an embodiment of a network environment is depicted. In brief overview, the network environment includes one or more clients 102a-102n (also generally referred to as local machine(s) 102, node(s) 102, client(s) 102, client node(s) 102, client machine(s) 102, client computer(s) 102, client device(s) 102, endpoint(s) 102, or endpoint node(s) 102) in communication with one or more remote machines 106a-106n (also generally referred to as server(s) 106 or remote machine(s) 106) via one or more networks 104. In some embodiments, a client 102 has the capacity to function as both a client node 102 seeking access to resources provided by a server and as a server providing access to hosted resources for other clients 102a-102n.

Although FIG. 1A shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped remote machines 106. In one of these embodiments, the logical group of remote machines may be referred to as a server farm 38 or a machine farm 38. In another of these embodiments, the remote machines 106 may be geographically dispersed. In other embodiments, a server farm 38 may be administered as a single entity. In still other embodiments, the server farm 38 includes a plurality of server farms 38. The remote machines 106 within each server farm 38 can be heterogeneous—one or more of the remote machines 106 or machines 106 can operate according to one type of operating system platform (e.g., WINDOWS NT, manufactured by Microsoft Corp. of Redmond, Wash.), while one or more of the other remote machines 106 can operate on according to another type of operating system platform (e.g., Unix or Linux).

In one embodiment, remote machines 106 in the server farm 38 may be stored in high-density rack systems, along with associated storage systems, and located in an enterprise data center. In this embodiment, consolidating the remote machines 106 in this way may improve system manageability, data security, the physical security of the system, and system performance by locating remote machines 106 and high performance storage systems on localized high performance networks. Centralizing the remote machines 106 and storage systems and coupling them with advanced system management tools allows more efficient use of server resources.

The remote machines 106 of each server farm 38 do not need to be physically proximate to another remote machine 106 in the same server farm 38. Thus, the group of remote machines 106 logically grouped as a server farm 38 may be interconnected using a wide-area network (WAN) connection or a metropolitan-area network (MAN) connection. For example, a server farm 38 may include remote machines 106 physically located in different continents or different regions of a continent, country, state, city, campus, or room. Data transmission speeds between remote machines 106 in the server farm 38 can be increased if the remote machines 106 are connected using a local-area network (LAN) connection or some form of direct connection. Additionally, a heterogeneous server farm 38 may include one or more remote machines 106 operating according to a type of operating system, while one or more other remote machines 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif., the Xen hypervisor, an open source product whose development is overseen by Citrix Systems, Inc., the VirtualServer or virtual PC hypervisors provided by Microsoft, or others.

Remote machine 106 may be a file server, application server, web server, proxy server, appliance, network appliance, gateway, gateway server, virtualization server, deployment server, SSL VPN server, or firewall. In some embodiments, a remote machine 106 provides a remote authentication dial-in user service, and is referred to as a RADIUS server. In other embodiments, a remote machine 106 may have the capacity to function as either an application server or as a master application server. In still other embodiments, a remote machine 106 is a blade server. In yet other embodiments, a remote machine 106 executes a virtual machine providing, to a user or client computer 102, access to a computing environment.

A computing device 100 may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on the computing device 100. In some embodiments, the application may be a server-based or a remote-based application executed on behalf of a user of a first computing device by a second computing device. In other embodiments, the second computing device may display output data to the first, client computing device using any thin-client or remote-display protocol, such as the Independent Computing Architecture (ICA) protocol manufactured by Citrix Systems, Inc. of Ft. Lauderdale, Fla.; the Remote Desktop Protocol (RDP) manufactured by the Microsoft Corporation of Redmond, Wash.; the X11 protocol; the Virtual Network Computing (VNC) protocol, manufactured by AT&T Bell Labs; the SPICE protocol, manufactured by Qumranet, Inc., of Sunnyvale, Calif., USA, and of Raanana, Israel; the Net2Display protocol, manufactured by VESA, of Milpitas, Calif.; the PC-over-IP protocol, manufactured by Teradici Corporation, of Burnaby, B.C.; the TCX protocol, manufactured by Wyse Technology, Inc., of San Jose, Calif.; the THINC protocol developed by Columbia University in the City of New York, of New York, N.Y.; or the Virtual-D protocols manufactured by Desktone, Inc., of Chelmsford, Mass. The application can use any type of protocol and it can be, for example, an HTTP client, an FTP client, an Oscar client, or a Telnet client. In other embodiments, the application comprises any type of software related to voice over internet protocol (VoIP) communications, such as a soft IP telephone. In further embodiments, the application comprises any application related to real-time data communications, such as applications for streaming video and/or audio.

The client 102 and remote machine 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, such as a mouse. The storage device 128 may include, without limitation, an operating system, software, and a client agent 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In some embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output DRAM (EDO DRAM), Burst Extended Data Output DRAM (BEDO DRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with a display device 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc., of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the client agent 120. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD, IPAD, or IPHONE families of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w/wx, 750, 755p, 800w, Centro, or Pro smart phone manufactured by Palm, Inc. In some of these embodiments, the TREO smart phone is operated under the control of the PalmOS operating system and includes a stylus input device as well as a five-way navigator device.

In other embodiments, the computing device 100 is a mobile device, such as a JAVA-enabled cellular telephone or personal digital assistant (PDA), such as the i55sr, i58sr, i85s, i88s, i90c, i95c1, i335, i365, i570, 1576, i580, i615, i760, i836, i850, i870, i880, i920, i930, ic502, ic602, ic902, i776 or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, the Blackberry PEARL 8100, the 8700 series, the 8800 series, the Blackberry Storm, Blackberry Bold, Blackberry Curve 8900, and the Blackberry Pearl Flip. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, California. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the ZEN VISION W, the ZEN VISION series, the ZEN PORTABLE MEDIA CENTER devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 100 includes a combination of devices, such as a mobile phone combined with a digital audio player or portable media player. In one of these embodiments, the computing device 100 is a Smartphone, for example, an IPHONE manufactured by Apple Computer, or a Blackberry device, manufactured by Research In Motion Limited. In yet another embodiment, the computing device 100 is a laptop or desktop computer equipped with a web browser and a microphone and speaker system, such as a telephony headset. In these embodiments, the computing devices 100 are web-enabled and can receive and initiate phone calls. In other embodiments, the communications device 100 is a Motorola RAZR or Motorola ROKR line of combination digital audio players and mobile phones.

### B. Improved Online Marketplace

Before discussing specifics of an improved online marketplace, it may be helpful to provide definitions and examples of a few terms as used herein:

Inventory: Inventory may refer to tangible items, such as books, clothing, or other goods; intangible items, such as e-books, movies, songs, or television shows; admission or access tickets, such as concert or sports tickets, museum tickets, plane tickets, train or bus tickets; access tokens, such as those used to access an online service, multiplayer network game, cloud computing application; or any other type and form of item, event, service, or attraction. Inventory may be limited in supply, as in the case of seats to a particular concert; limited in time, as in the case where tickets to an event may be useless after the event occurs; temporarily limited in supply, as in the case of a newly released video game system; limited in a combination of these; or not limited at all. Inventory may be fungible, such as a copy of a software program, or non-fungible, such as a particular seat to a sporting event. Single items, tickets, tokens, attractions, services, or other singular units of inventory may be referred to generally as an item or ticket. In many embodiments, the term inventory may not refer to the specific item, but rather an identifier of the item. For example, when a concert promoter provides 100 admission tickets of inventory to the online marketplace, in many embodiments, the concert promoter sells the 100 admission tickets to the marketplace operator, provides a contract to sell the 100 admission tickets at a future date, provides an identifier that the 100 admission tickets have been sold although they remain in the possession of the concert promoter, etc. Thus, tangible items may not actually change hands when inventory is provided to the marketplace. Inventory may be acquired from original providers of the inventory, resellers, or online marketplaces.

Event: Events may refer to sporting events, concert events, lectures, or other shows. Events may occur at specific places and times, although multiple instances of the event may occur, such as multiple shows. An event may comprise both a type of event (such as “NHL Hockey”) and a particular team, performer, or other relevant identifier (such as “Maple Leafs”). In some embodiments, events may refer to any time-limited event, such as a particular plane flight (e.g. “American Airlines Flight 272 from BOS to LAX”), in which case the event type may be “Airline Flight” or a similar designator.

Event Type: An event type may comprise an overall class of event, such as a sporting league (e.g. “NFL Football,” “NHL Hockey”), a “Music Concert,” a “Theater Show,” a “Comedy Show,” a “Speaker,” or any other type of event.

Bid: A bid from a user, broker, or other entity to purchase an item or ticket. Referred to variously as a bid or an offer, these terms refer to a proposal that, if accepted, may constitute a binding agreement or contract. A bid may be successful or unsuccessful. Bids may be electronic or delivered electronically, entered through an interface such as a web interface, or provided via telephone or other means.

New Customer: A new customer may comprise a customer that has not previously bid for an item or is not in a user database.

Lapsed Customer: A lapsed customer may comprise a customer that has not bid in a predetermined time period, or lapsed time frame.

Churn Risk Customer: A churn risk customer may refer to a customer with a high likelihood of becoming a lapsed customer. In one embodiment, a churn risk customer is a customer who has had a high percentage (greater than a predetermined percentage, or churn risk percentage) of unsuccessful bids in a predetermined time period, or churn risk time frame.

Cannibalization Risk: A cannibalization risk may occur when the system may be cannibalizing inventory providers' profit by offering lower prices to purchasers who would have purchased at a retail price from the providers directly. In some embodiments, a cannibalization risk may occur when a customer has had a predetermined number of successful bids for a given event or item in a predetermined time period, or event cannibalization timeframe.

Counter Offer Event: When a customer has bid unsuccessfully, the system may provide a counter offer. This counter offer can involve a change in the price as well as a change in the item (e.g. tickets for seats in a less desirable location for the same event). If this offer is accepted by the customer then it is automatically fulfilled. In some embodiments, this may occur where the user's bid is above a predetermined threshold, which may be a percentage of the current market price, or a buy it now or counter offer threshold.

Cross Sell or Up Sell Opportunity: A customer may be a cross sell or up sell opportunity when the customer may be likely to purchase similar items or upgrade the purchase. Criteria to recognize these opportunities may include a purchase history of the customer; a geographical location of a first item or items (for example, a purchaser from San Francisco buying tickets to shows in New York City may be interested in other shows in New York City around the same dates, as they may be on a vacation); or where similar customers have purchased similar items or upgrades (for example, if a large portion of Super Bowl ticket purchasers also purchase team jerseys, a person bidding on Super Bowl tickets may represent an opportunity to cross sell a jersey). It may also involve an opportunity to share the deal, which may comprise allowing the customer to invite other customers to purchase items at the same price as the original customer's price. For example, if a customer buys four tickets to a certain event, the system may put a further six contiguous seats on hold to be purchased by customers referred by the first customer to purchase at the same winning bid price.

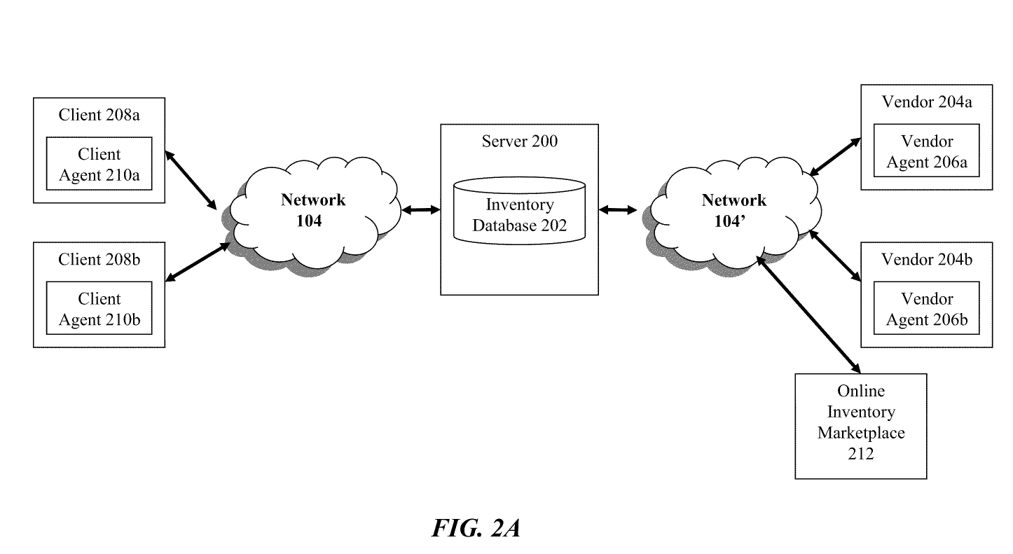

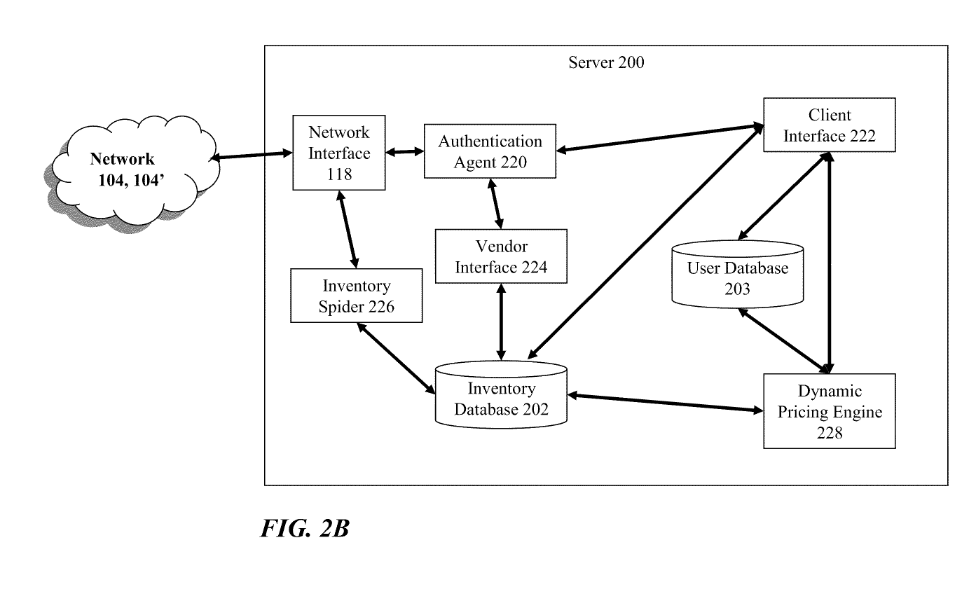

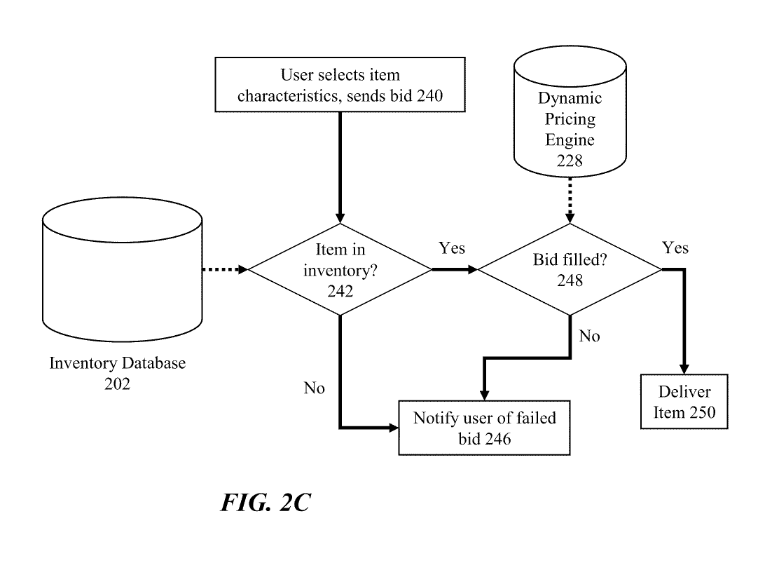

In many embodiments, it may be desirable to separate purchasers and sellers with an opaque marketplace to prevent goodwill of a seller from being eroded when pricing inventory at above-face value, but at-market price rates. Similarly, an opaque marketplace also allows inventory providers to sell unsold inventory at below-face value rates without eroding the goodwill of purchasers who bought at-face value, or having to go through an additional ticket broker or reseller. FIG. 2A is a block diagram of an embodiment of a system providing an opaque online marketplace. In brief overview, a server 200 may comprise an inventory database 202. The server 200 may communicate via one or more networks 104 and 104′ with one or more vendors 204a-204b and clients 208a-208b. Vendors 204a-204b may comprise vendor agents 206a-206b. Similarly, clients 208a-208b may comprise client agents 210a-210b. In some embodiments, server 200 may also communicate via a network 104 or 104′ with an online inventory marketplace 212.

Still referring to FIG. 2A and in more detail, in some embodiments, server 200 may comprise a computing device, such as any of the computing devices discussed above, for providing an opaque online marketplace. Server 200 may comprise an inventory database 202, discussed in more detail below. Although shown as a single server 200, in many embodiments, server 200 may represent a plurality of servers, either with designated functions or serving as backups, or as a server farm. Server 200 may thus represent one or more web servers, one or more database servers, and one or more application servers, the combination referred to generally as server 200. Application servers may include servers for handling check outs and finalizing transactions, servers for importing data from third parties, or other tasks. In some embodiments, server 200 may communicate via one or more networks 104 and 104′ with clients and vendors. Although shown as separate networks, in many embodiments, server 200 may communicate with vendors and clients via a single network 104.

In some embodiments, a vendor 204a-204b (referred to generally as a vendor 204) may comprise a computing device, such as one of the computing devices discussed above, used by an inventory provider. A vendor 204 may thus be considered a client computing device of an inventory provider. In some embodiments, a vendor 204 may include a vendor agent 206a-206b (referred to generally as a vendor agent 206). Vendor agent 206 may comprise an interface for accessing server 200, such as a web browser, application, GUI, CLI, or other interface, to provide inventory, set thresholds or take other actions. In other embodiments, vendor agent 206 may comprise an application, service, daemon, or other executable logic for providing inventory to server 200, with or without direct human intervention. For example, vendor agent 206 may be an automated service that provides inventory to the marketplace when made available by the manufacturer, broker, promoter, or other entity.

In some embodiments, a client 208a-208b (referred to generally as a client 208) may comprise a computing device, such as one of the computing devices discussed above, used by a user, purchaser, or customer. A client 208 may thus be considered a client computing device of a customer. In many embodiments, client 208 may comprise a portable computing device, such as a Smartphone. In some embodiments, a client 208 may include a client agent 210a-210b (referred to generally as a client agent 210). Client agent 210 may comprise an interface for accessing server 200, such as a web browser, application, GUI, CLI, or other interface to bid, provide billing information, and purchase inventory.

In some embodiments, an online inventory marketplace 212 may comprise an online reselling marketplace, such as eBay, Craigslist, or another market. In other embodiments, an online inventory marketplace 212 may comprise a manufacturer or retailer's web store or other site where inventory can be ordered or purchased. In many embodiments, online inventory marketplace 212 may be provided by a computing device, such as the computing devices discussed above. In some embodiments, discussed in more detail below, server 200 may execute a spider, daemon, service, or other executable code, to automatically access one or more online inventory marketplaces 212 to find and order or purchase inventory for the marketplace, as if it were another customer. Thus, in these embodiments, server 200 may obtain inventory without a vendor directly being aware that the inventory is being purchased for resale.

Referring now to FIG. 2B, illustrated is a block diagram of an embodiment of a server providing an opaque online marketplace with dynamic pricing. In brief overview, server 200 may comprise a network interface 118, discussed above. Server 200 may also comprise an authentication agent 220, a client interface 222, and a vendor interface 224. In many embodiments, server 200 may include an inventory database 202 and a user database 203. Server 200 may execute, in some embodiments, an inventory spider 226, and a dynamic pricing engine 228. Although illustrated on a single server 200, some or all of these modules may be executed by different servers in communication with each other via a LAN, MAN, WAN, or other network. In some embodiments, the modules may comprise applications and data provided by a cloud service. In some embodiments, server 200 may comprise or communicate with other components or modules, such as a billing module or checkout module to handle charging or receiving of payment for successful bids.

Still referring to FIG. 2B and in greater detail, in one embodiment, server 200 may include an inventory database 202. Inventory database 202 may comprise a database, hierarchical tree, data file, or other data structure for storing identifiers or records representing inventory. Inventory records may comprise event types, descriptions, event times, locations, seat numbers, ISBNs, retail or face value prices, current market prices, historical market prices, volumes or numbers of inventory items or tickets remaining, or any other type and form of identifier.

In some embodiments, server 200 may include a user database 203. User database 203 may comprise a database, hierarchical tree, data file, or other data structure for storing identifications or records of users and/or vendors, referred to generally as user records. A user record may comprise a user name, account name, password, login name, IP address, shipping address, billing address, phone number, age or date of birth, preferred billing method, credit card or other billing information, or other items of personal information or user credentials. In some embodiments, a user record may include a purchase or bid history. For example, a user record may include one or more bids and identification of items bid upon, timestamps for the one or more bids, whether the bids were successful or unsuccessful, or any other historical bid or purchase information. This data may be used to identify a new user, returning user, churn risk customer, or cannibalization risk.

In some embodiments, server 200 may include an authentication agent 220. Authentication agent 220 may comprise an application, service, applet, subroutine, daemon, or other executable code for verifying the identity of a user. A user, generally, may comprise a vendor, broker, customer, or administrator. Authentication agent 220 may be used to identify the user and direct them accordingly to one or more interfaces, such as a client interface 222 or vendor interface 224. Authentication agent 220 may communicate with, read from, or write to a user database 203 to uniquely identify a user during login. In some embodiments, authentication agent 220 may comprise functionality for encrypting or decrypting communications with a user.

In some embodiments, a server 200 may include a client interface 222. In some embodiments, a client interface 222 may comprise a web page, web application, remote application interface, or other interface used by a customer to bid and/or purchase items or tickets. In other embodiments, client interface 222 may comprise a service configured to deliver data to a client agent 210. For example, in one embodiment in which client agent 210 is a Smartphone application, client interface 222 may deliver data for display by the Smartphone application. In many embodiments, client interface 222 may allow a customer to search for items or tickets, browse items or tickets, bid on items or tickets, view previous bids, view outstanding bids, complete purchases, accept a counter offer, update account information, or receive or provide other information. In some embodiments, client interface 222 may be used to deliver an electronic ticket to a successfully bidding customer, for example, as a barcode, two-dimensional code, confirmation number, or other value.

In some embodiments, a server 200 may include a vendor interface 224. A vendor interface 224 may comprise a web page, web application, remote application interface, or other interface used by a vendor or administrator to provide inventory to inventory database 202. In many embodiments, vendor interface 224 may be used to allow a vendor to set thresholds or parameters for the inventory, such as churn risk thresholds, counter offer thresholds, discount parameters, time until event, face value or default retail price, or other classifications, parameters, or thresholds of the inventory.

In many embodiments, server 200 may execute or communicate with an inventory spider 226. Inventory spider 226, sometimes referred to as a web crawler, indexer, bot, robot, crawler, or software agent may comprise an application, service, daemon, subroutine, or other executable logic for searching one or more online inventory marketplaces 212 for inventory. In some embodiments, inventory spider 226 may include functionality for finding sources of inventory, and purchasing said inventory to add to inventory database 202. This may be done, for example, where inventory is limited.

Server 200 may include a dynamic pricing engine 228. Dynamic pricing engine 228 may comprise an application, service, routine, logic, or other executable code for determining a dynamic market price. In some embodiments, determining a dynamic market price may further comprise determining a user-specific market price adjustment, responsive to one or more user factors. Dynamic pricing engine 228 may include a historical database of market pricing information, not shown, for tracking trends in bids and market price over time.

Referring now to FIG. 2C, illustrated is a flow chart of an embodiment of an opaque online marketplace with dynamic pricing. As shown, at step 240, a user may select an item and place a bid on the item. In many embodiments, the user is a customer or potential customer. Selecting the item may comprise browsing through a list of items, events or attractions; browsing through a list of items, events or attractions filtered by one or more qualities, such as geographic location, date, time, price, or other characteristics; searching by characteristic for a specific item or items; or via other means. Once a user has selected the item or event, the user may place a bid for the item at a price defined by the user. In some embodiments, the user may define the price without knowledge of a current dynamic market price of the item. In other embodiments, the user may define the price without knowledge of a face value or default retail price of the item. In still other embodiments, one or more characteristics of the item may be undefined at the time of bidding. For example, and discussed in more detail below, in some embodiments in which a user is bidding on tickets to a sporting event, concert, or other event, the user may bid on one or more seats selected by class (e.g. balcony, orchestra, box) or by rating (e.g. one star, two star, three star, etc.). Accordingly, a specific seat may be unknown at time of bidding.

At step 242, the system may determine if the selected item exists in inventory 202. If not, then at step 246, the user may be notified of the failed bid. In some embodiments, the user may further be notified that the selected item does not exist in inventory 202. In embodiments in which the item is time-dependent, such as concert tickets or sporting event tickets, the item may be unavailable because the event starting time has passed. Accordingly, in such embodiments, the user may be notified that the event has occurred at step 246.

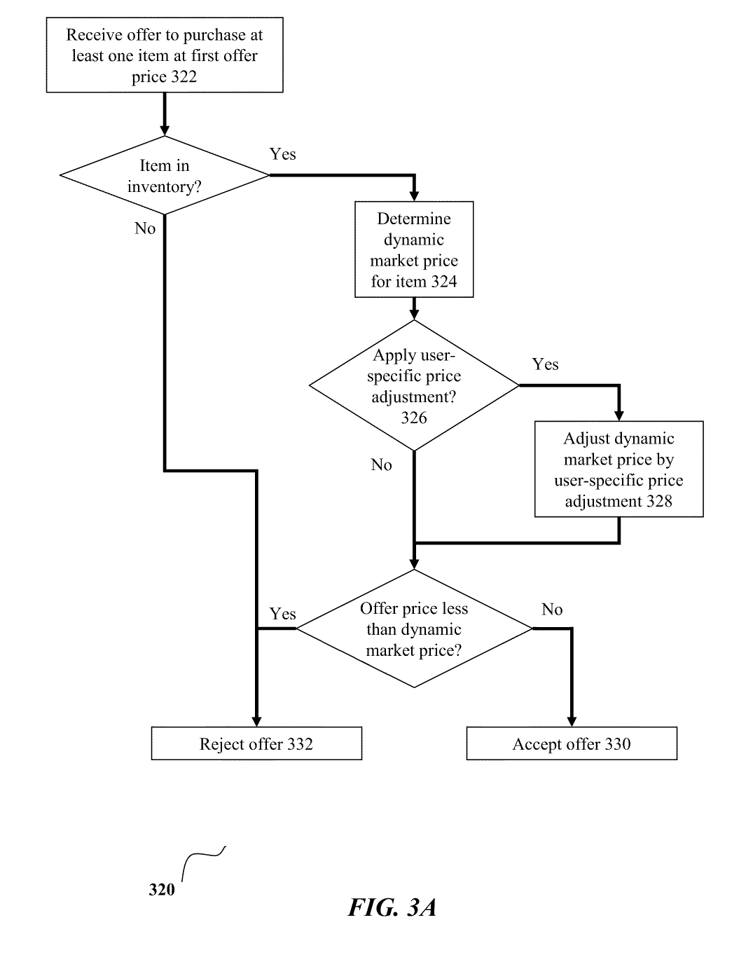

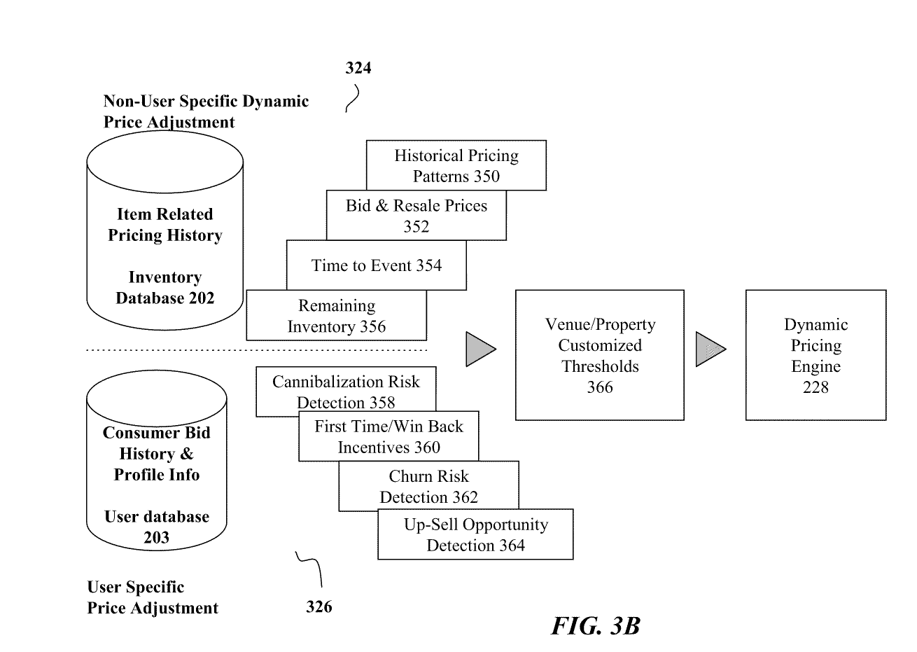

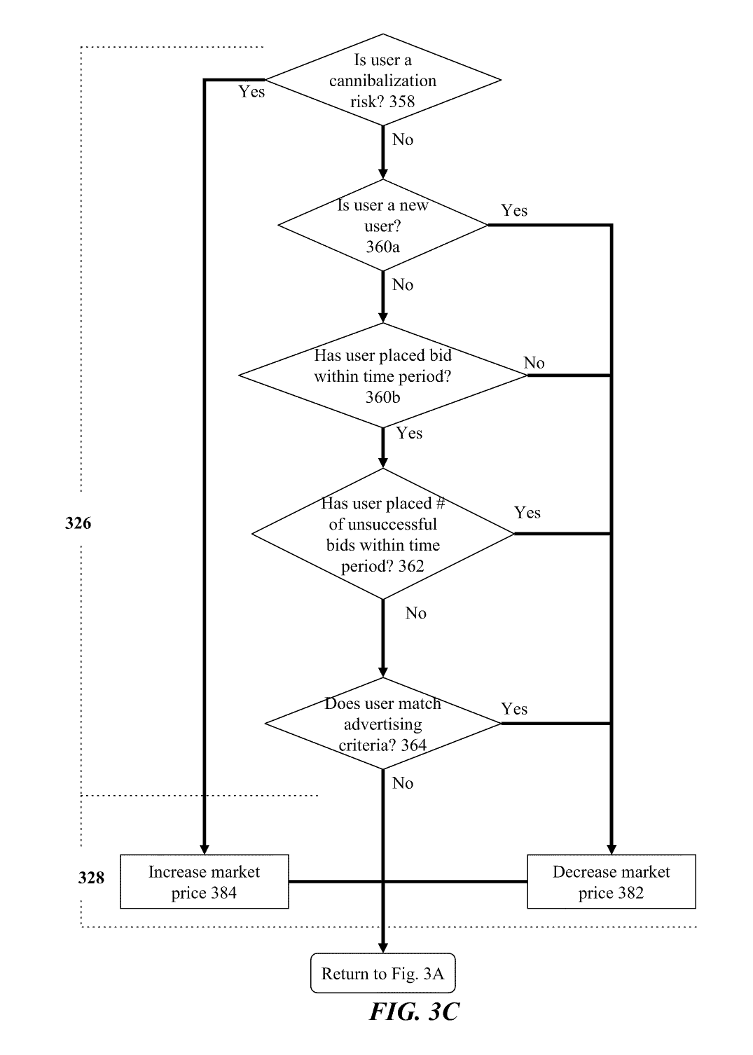

If the item exists in either inventory 202, then at step 248, the dynamic pricing engine 228 may determine if the bid should be filled or accepted. The determination may be performed responsive to the user's bid, a dynamic market price, and one or more user-specific price adjustments responsive to characteristics of the user, discussed in more detail below in connection with FIGS. 3A-3D. If the dynamic pricing engine 228 determines the bid should not be filled, then at step 246, the user may be notified of the failed bid. In some embodiments, discussed in more detail below, the user may be provided an opportunity to buy the item at a counter offer price. If the dynamic pricing engine 228 determines that the bid should be filled, then at step 250, the system may accept or fill the bid, and deliver the item. In many embodiments, delivering the item may comprise directing a third party to deliver the item. For example, in one embodiment in which the item is a ticket, delivering the item may comprise notifying the event operator that the user has purchased the ticket and should be listed on a will-call list. Delivering the item may further include charging or billing the user the bid amount.

Illustrated in FIG. 3A is a flow chart of an embodiment of a method 320 for accepting offer bids with a dynamically adjusted market price in an opaque marketplace. In brief overview, at step 322, a server or client interface on a server may receive an offer to purchase at least one item at a first offer price. As discussed above in connection with FIG. 2C, the server or client interface may determine if the item exists in inventory. If the item is not available in inventory, then at step 332, the server or client interface may reject the offer.

If the item is available, then at step 324, the server or a dynamic pricing engine of the server may determine a dynamic market price for the item. At step 326, the server or dynamic pricing engine may determine whether to apply a user-specific price adjustment to the dynamic market price. If so, the server or dynamic pricing engine may adjust the dynamic market price by a user-specific price adjustment at step 328. Steps 326 and 328 are discussed in more detail in connection with FIGS. 3C and 3D. If the offer price is less than the determined or determined and adjusted market price, then at step 332, the offer may be rejected. If not, at step 330, the offer may be accepted.

Still referring to FIG. 3B and in more detail, at step 322, the server may receive an offer to purchase at least one item at a first offer price. In many embodiments, the server may receive the offer or bid from a second computing device, such as a client computing device. In some embodiments, the offer or bid may be an electronic offer or bid, provided to or made through a client interface provided by the server. Accordingly, receiving an offer may comprise receiving the offer, or it may comprise receiving a number of selections or inputs comprising the offer. In some embodiments, the item may comprise a seating ticket for an event. In other embodiments, the item may comprise a good, service, admission to an attraction, a travel ticket, or any other type and form of purchasable item.

At step 324, provided the item is available in inventory, the server or a dynamic pricing engine of the server may determine a dynamic market price for the at least one item. In some embodiments, the dynamic market price may comprise a first market price. In one embodiment, the first market price may correspond to a face-value or default retail price for the at least one item, the face-value or default retail price set by a provider of the at least one item. In another embodiment, the dynamic market price may comprise a second market price, determined responsive to the offer price and a first market price. In many such embodiments, the first market price is a previously determined dynamic market price. For example, in one embodiment, the second market price may comprise a weighted average of the first market price and the offer price. With each new offer, the dynamic market price may be updated responsive to the previous market price and the new offer price. In many embodiments, a function may be used to weight the two prices differently, such that a new very low or very high offer cannot cause dramatic change in the determined dynamic market price. In some embodiments, the dynamic pricing engine may determine the dynamic market price responsive to a size of an unsold inventory of the at least one item. For example, in some embodiments, as the unsold inventory shrinks, the dynamic pricing engine may increase the dynamic market price. In other embodiments, the dynamic pricing engine may determine the dynamic market price responsive to a time before close of a market on the at least one item. For example, in some embodiments, as the time before close approaches, such as when a start time for an event approaches, the dynamic pricing engine may reduce the dynamic market price to attempt to sell off all remaining unsold inventory.

At step 326, the dynamic pricing engine may determine whether to apply a user-specific price adjustment. This may be done responsive to one or more characteristics of the user. If so, at step 328, the dynamic pricing engine may adjust the dynamic market price by a user-specific price adjustment. Both of these steps are discussed in more detail below in connection with FIGS. 3C and 3D.

If the offer price is equal to or greater than either the determined dynamic market price or the adjusted dynamic market price, depending on whether the adjustment was applied, then the server or dynamic pricing engine may accept the offer price at step 330. In some embodiments, the dynamic pricing engine may determine to accept the offer responsive to the determined or adjusted dynamic market price being less than or equal to the offer price. In many embodiments, accepting the offer may comprise notifying the bidder that the offer was accepted, charging or billing the bidder, delivering the item or notifying a third party that the item has been purchased, or performing other tasks to fulfill the accepted offer.

If the offer price is less than the dynamic market price or adjusted dynamic market price, depending on whether the adjustment was applied, then at step 332, the server or dynamic pricing engine may reject the offer. In some embodiments, rejecting the offer may comprise transmitting a response indicating that the offer was declined, was too low, or a similar response. In a further embodiment, the dynamic pricing engine may determine to present the customer with a counter offer. In one embodiment, this may be done responsive to determining that the offer price is within a predetermined percentage of the determined or adjusted market price. For example, if the offer price is only 5% lower than the adjusted market price, the customer may be presented with an opportunity to make a second offer at the adjusted market price to buy the item that will be immediately accepted. In other embodiments, different percentages or metrics may be used. In some embodiments, the counter offer may also involve a change in one or more terms of the item offered. For example, in one such embodiment, the customer may be offered the chance to purchase seats in a different location of the venue for the same original offer price. In other embodiments, the customer may be offered the chance to purchase seats for a different showing or time of the event for the same offer price.

Referring now to FIG. 3B, illustrated is a block diagram of an abstraction of a system for dynamically adjusting market price. As shown, in calculating a dynamic price, the dynamic pricing engine 228 may balance dynamic price adjustments 324 against user-specific price adjustments 326, further limited by venue/property customized thresholds 366.

As discussed above, a market price may be dynamically adjusted based on a previous market price and an offer, or based on item related pricing history. Such history may be stored in an inventory database 202. In many embodiments, the market price may be further adjusted based on historical pricing patterns 350. It may be observed that demand for an item or event rises periodically or based on some time frame. For example, demand for flowers frequently increases prior to Valentine's Day. Accordingly, pricing patterns from previous years may be used to increase the dynamic market price slightly sooner than demand to allow proactively capturing additional profit from early bids. Historical pricing patterns 350 may be annual, monthly, seasonal, weekly, daily, hourly, or any other time frame.

Similarly, bid and resale prices 352 may be used to dynamically adjust the market price. For example, as discussed above, a market price may be adjusted responsive to new bids, as an average of these bids will frequently represent what a large portion of the consumer crowd is willing to pay. Resale prices may also be used, to prevent placing a market price below a resale market price in another secondary market, creating arbitrage opportunities that represent lost profits.

Also as discussed above, when an item or event is time-limited, a time to event 354 may be used to adjust the dynamic market price. In many embodiments, as the time to event 354 approaches, the dynamic pricing engine may reduce the market price to sell off any remaining unsold inventory. In many cases, it may be preferable to have a fully attended event, even if the last seats are sold at or below cost, because attendees frequently purchase additional items. For example, at many sporting events, attendees frequently purchase food, beverages, programs, apparel, posters, souvenirs, or other articles. Profit margins may be high enough on these articles that it is desirable to have attendees who paid for their seats below cost. In many embodiments, the time to event 354 may comprise a predetermined time prior to the event. For example, the time to event 354 used for dynamic pricing and/or used for preventing further sales of the item may be a number of hours prior to the event. This allows sales to be finalized and transmitted to the event operator.

Similarly, when an item or event is volume-limited, such as the number of seats on a plane or in a venue, or where an inventory of a good is limited, a remaining inventory 356 value may be used for dynamic pricing. In some embodiments, as the supply decreases, the dynamic pricing engine may increase the market price to capture maximum profit from available user demand. In other embodiments, as the supply decreases and in conjunction with the time to event 354, the dynamic pricing engine may decrease the market price to sell remaining unsold inventory.

In addition to dynamic price determination based on the item 324, in many embodiments, the dynamic pricing engine may incorporate user specific price adjustments 326. User specific price adjustments 326 may be based on a consumer bid history and/or profile information stored in user database 203, and associated with the user upon login or registration.

In many embodiments, user specific price adjustments 326 may comprise adjusting the dynamic market price based on cannibalization risk detection 358. Cannibalization risks may comprise instances where a user may be willing to pay retail price from the event provider. For example, a user may be identified as a full-price purchaser based on making a predetermined number of successful bids for a given event or item in a predetermined time period, or event cannibalization timeframe. In such cases, and transparently to the user, the dynamic pricing engine 228 may increase the dynamic market price for that user, such that the lowest possible accepted bid by the user is higher than for other users.

In other embodiments, a user specific price adjustment may be applied for first time users or to win back users 360. For example, to encourage a first time user to become a return user, the dynamic market price may be decreased for that first time user allowing them to purchase the item at a below market rate. This may please the user such that they return to purchase other items. Similarly, if the user is not a new user, but has not placed a bid within a predetermined time period, the dynamic market price may be decreased to win back the user or encourage them to bid more often.

Similarly, in some embodiments, users may be detected as potential churn risks 362 based on their bid history, and the dynamic market price may be decreased to keep the user satisfied. Because it's very difficult to win back users once they have completely left the system, it may be desirable to decrease the price periodically for these users. For example, if a user has made a predetermined number of bids within a predetermined time period, and a predetermined percentage of those bids have been unsuccessful, then the system may predict that the user will become unsatisfied and potentially leave. Accordingly, the dynamic pricing engine 228 may decrease the dynamic market price to allow the user to have a successful bid, even when they're bidding below the market price.

In some embodiments, the dynamic pricing engine may reduce a dynamic market price responsive to up-sell opportunity detection 364. For example, as mentioned above, many event attendees frequently purchase food, beverages, and other concessions at an event. In some embodiments, an opportunity may exist to capitalize on these purchases by offering the user an opportunity to pre-purchase concessions. For example, the system may offer the user a prepaid concession coupon, perhaps at a discount (e.g. $10 for a $20 concession voucher). In other embodiments, a customer may wish to purchase ticket insurance to provide a refund in case they have to cancel. In still other embodiments, the customer may wish to prepay for parking for an event. In still other embodiments, the customer may be interested in other events or items. For example, the dynamic pricing engine may determine that a large percentage of customers who bid on a first item or event also bid on a second item or event. For example, customers bidding on tickets for a pre-season football game may also be highly likely to bid on a season game or post-season game. Similarly, the dynamic pricing engine may provide recommendations for other events or items due to a geographic location. For example, a customer in Los Angeles bidding on a theater ticket in New York City may be on vacation at that time, and may be interested in other events in New York City in the same week or few days. Users who have had a successful bid on a first item may be more likely to bid or accept a counter offer for additional items. Accordingly, in many embodiments, the dynamic pricing engine may reduce the dynamic price responsive to detecting an up-sell opportunity.

In many embodiments, the non-user specific and user-specific adjustments to the dynamic market price performed by the dynamic pricing engine 228 may be limited by one or more venue or property customized thresholds 366. For example, in one embodiment, a venue or inventory provider may set a floor on what they will allow inventory to be sold for, such as a maximum of 60% below a default retail price or face value. In other embodiments, indirect parameters that control the dynamic market price may be limited via thresholds. For example, a vendor may set a cutoff time prior to an event to stop selling tickets, such as four hours. Any of the time frames, thresholds, and percentages discussed herein may be configured by an administrator or vendor, on an item or ticket specific basis.

Referring now to FIG. 3C, illustrated is a flow chart of an embodiment of a method of adjusting a market price by a user specific price adjustment. The flow chart of FIG. 3C may correspond to some embodiments of the method shown in FIG. 3A. For example, the five decisions may together comprise step 326 (determining whether to apply a user-specific price adjustment), and the two adjustments may comprise step 328 (applying the user-specific price adjustment). Accordingly, when FIG. 3C returns to FIG. 3A, in many embodiments, this may comprise returning to FIG. 3A after steps 326 and 328 (at the determination of whether to accept or reject the offer). In brief overview, in some embodiments, the method of adjusting a market price by a user specific price adjustment comprises performing one or more of a cannibalization risk detection 358, first time/win back incentives 360a-360b, churn risk detection 362, and/or up-sell opportunity detection 364.

Although the embodiment shown in FIG. 3C includes all of these criteria, in many embodiments, one or more steps may be omitted. Furthermore, although the embodiment shown in FIG. 3C shows only a single step for each of increase market price 384 or decrease market price 382, in many embodiments, multiple adjustments may be made responsive to a user matching a plurality of criteria. Such adjustments may be in different amounts, in many embodiments. For example, in one embodiment, a first time user may be given a 20% discount, while an up-sell user may be given a 10% discount. The amount of various adjustments may be predetermined and correspond to each the criteria. Accordingly, in one embodiment, steps 358-364 may be interspersed with steps 382 and 384. For example, if the user is determined at step 360a to be a new user, then the market price may be decreased at step 382, and the method may then proceed to one or more of steps 360b-364. If the user is both a new user and matches advertising criteria for an up-sell or cross-sell opportunity, in such embodiments, step 382 may be applied for each condition and two separate market price adjustments may be applied. Such adjustments may be the same, different, and may be cumulative or non-cumulative

Still referring to FIG. 3C and in more detail, at step 358, the dynamic pricing engine may determine if the user is a cannibalization risk. In one embodiment, this may comprise determining if the user has placed a number of successful bids within a predetermined time period. If so, the user may be considered a cannibalization risk. In some embodiments, the number of successful bids may be a predetermined number of bids, while in other embodiments, the number of successful bids may be a predetermined percentage of a total number of bids placed within the predetermined time period. In further embodiments, the determination may be made responsive to the user having placed a predetermined number of total bids within the predetermined time period. This may be done, for example, to prevent a user with a single successful bid (and therefore a 100% successful bid rate) from immediately being considered a cannibalization risk. In some embodiments, the dynamic pricing engine may make the determination responsive to reading a historical bid record in a user record in the user database. If the user is determined to be a cannibalization risk at step 358, then at step 384, the dynamic pricing engine may increase the dynamic market price by a predetermined amount.

At step 360a, the dynamic pricing engine may determine if the user is a new user. In some embodiments, the dynamic pricing engine may determine that a user record corresponding to the user is not in a user database. In other embodiments, the dynamic pricing engine may determine that the user record corresponding to the user indicates that the user is a new user, or that the user has not previously made a bid, by reading a historical bid record or other identifier within the user record. If the user is a new user, then at step 382, the dynamic pricing engine may decrease the dynamic market price by a predetermined amount.

At step 360b, the dynamic pricing engine may determine if the user has placed a bid within a predetermined time period. If not, the dynamic pricing engine may provide a win back incentive, or decrease the dynamic market price by a predetermined amount at step 382. In one embodiment, the predetermined time period may be configured by an administrator of the system, and may be on a system-wide basis, item-specific basis, event type basis, or any other basis. This may be done, for example, to accommodate events that have long periods between occurrences, such as New Year's Eve dinner reservations or a Christmas-timed showing of the Nutcracker ballet, as opposed to events that occur frequently, such as weekly football games. Accordingly, different events or items may have different predetermined time periods used for detecting lapsed customers to be won back. In some embodiments, the dynamic pricing engine may make the determination responsive to reading a historical bid record in a user record in the user database.

At step 362, the dynamic pricing engine may determine if the user is a churn risk, responsive to the user having placed a number of unsuccessful bids within a predetermined time period. In some embodiments, the number of unsuccessful bids may be a predetermined number of bids, while in other embodiments, the number of unsuccessful bids may be a predetermined percentage of a total number of bids placed within the predetermined time period. In further embodiments, the determination may be made responsive to the user having placed a predetermined number of total bids within the predetermined time period. This may be done, for example, to prevent a user with a single unsuccessful bid (and therefore a 100% unsuccessful bid rate) from immediately being considered a churn risk. In some embodiments, the dynamic pricing engine may make the determination responsive to reading a historical bid record in a user record in the user database. If the user is determined to be a churn risk at step 362, then at step 382, the dynamic pricing engine may decrease the dynamic market price by a predetermined amount.

At step 364, the dynamic pricing engine may determine if the user matches one or more advertising criteria for an up-sell or cross-sell opportunity. In some embodiments, determining if the user matches one or more advertising criteria may comprise identifying that the user's bid history matches bid history of others who have made further bids or purchases. In other embodiments, determining if the user matches one or more advertising criteria may comprise identifying that a bid-for event is outside of the user's geographical region, and that inventory exists of similar events in the same area and time. In still other embodiments, determining if the user matches one or more advertising criteria may comprise identifying that the user's bid history indicates they are likely to bid for or purchase additional offered items or services, such as ticket insurance, parking, or pre-paid concessions. If the user is determined to be an up-sell or cross-sell opportunity, then at step 382, the dynamic pricing engine may decrease the dynamic market price by a predetermined amount.

As discussed above, at step 382 or at step 384, the dynamic pricing engine may decrease or increase the dynamic market price by one or more predetermined amounts or percentages. It should be understood that the adjustment made to the dynamic market price is user-specific. If two users are simultaneously bidding on an item, the dynamic pricing engine may use the same non-user specific dynamic market price for both users at, for example, step 324 of FIG. 3B. However, the dynamic market price may be adjusted separately for each user at steps 382 and 384 such that even with identical bids, one user's bid may be accepted while the other user's bid may not be. In some embodiments, the price may be increased or decreased by any percentage, including 1%, 2%, 5%, 10%, 20%, 25%, 30%, 50%, or any other amount. In other embodiments, the price may be increased or decreased by a predetermined value. However, this may be less useful, because of the variability of pricing of items: a predetermined $5 discount may be huge for a $10 item, but negligible for a $1000 item. Once the dynamic market price has been adjusted one or more times, as discussed above, the method may return to the method illustrated in FIG. 3B and determine whether to accept or reject the offer, and/or whether to offer counter offer opportunities, up-sell opportunities, or cross-sell opportunities. Where the user matches advertising criteria at step 364, the determination may be used to determine whether to present up-sell or cross-sell opportunities after accepting the bid at step 330.

Although discussed above as a user-specific adjustment to a dynamic market price, in some embodiments, a similar method may be performed with user-specific adjustments to the user's bid. For example, a user's bid may be increased by the system responsive to determining the user is a first time bidder. Because it is the difference between the bid and adjusted market price or adjusted bid and market price rather than the specific amounts used to determine whether to accept or reject the offer, the method will have the same result. However, it may be preferable to use user-specific adjustments to the dynamic market price to ease accounting: the user will be billed the amount that they bid. If the user's bid is adjusted, then the non-adjusted bid needs to be remembered so that billing is correct.

### C. Exemplary Embodiments of an Improved Online Marketplace

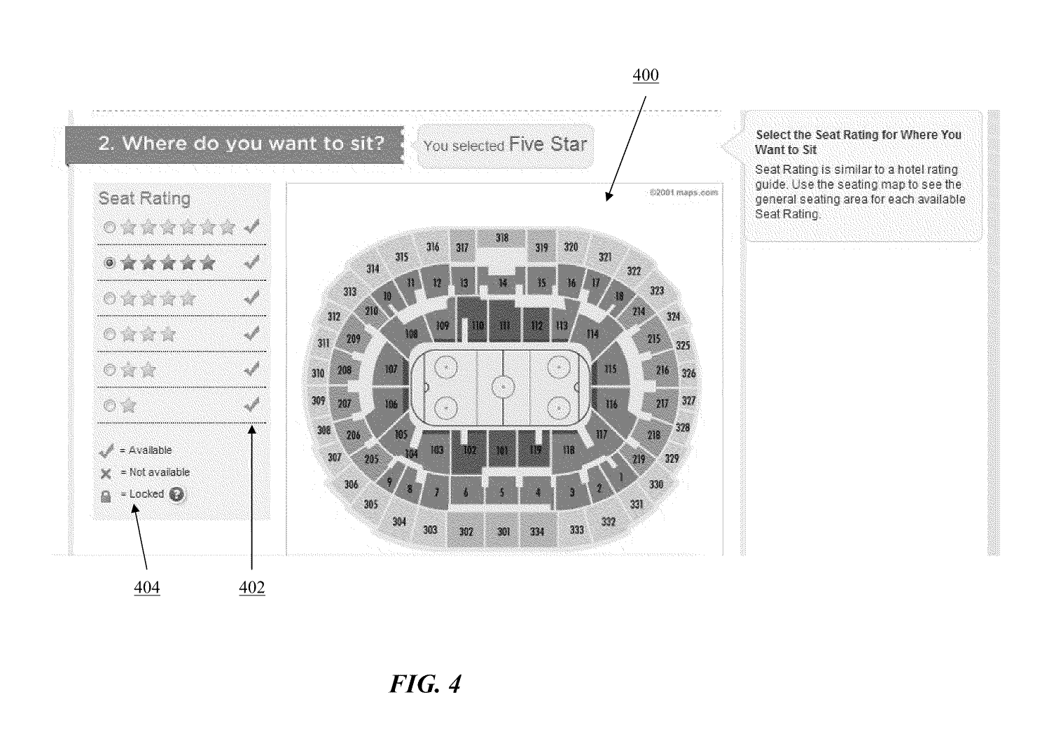

Illustrated in FIGS. 4-27 are screenshots of exemplary embodiments of an improved online market place incorporating the systems and methods described above. The following examples are intended to be non-limiting, but may be useful for explanatory purposes. Nonetheless, one skilled in the art may readily envision other embodiments that do not depart from the scope of the systems and methods described herein. Furthermore, although many of the examples shown are directed to embodiments in which the inventory items are tickets to shows or sporting events, as discussed above, the systems and method discussed herein may be applied to other items, services, or attractions including travel tickets, hotel reservations, restaurant reservations, books, clothing, music, movies, time coupons for a service such as a multiplayer game, cloud computing application, or VoIP service, or any other purchasable item or service.

Referring to FIG. 4, in some embodiments in which the item of inventory is a ticket to an event, such as a concert, theater show, sporting event, or other similar attraction, in many embodiments, a user may bid on the ticket based on a characteristic of the ticket. For example, rather than bidding on a specific seat (which may require a client interface to search an inventory for available seats prior to the user making even a first bid), the user may bid on a class of seats, such as orchestra, balcony, rink-side, loge, midfield, or similar class, or may bid on seats based on a seat rating. In one embodiment, seats within a venue may be rated 400, for example from one to six stars as shown, or on any other scale. In some embodiments, seat classes may be marked with an indicator 402, identifying them as available, not available, or locked/reserved, according to a key 404.

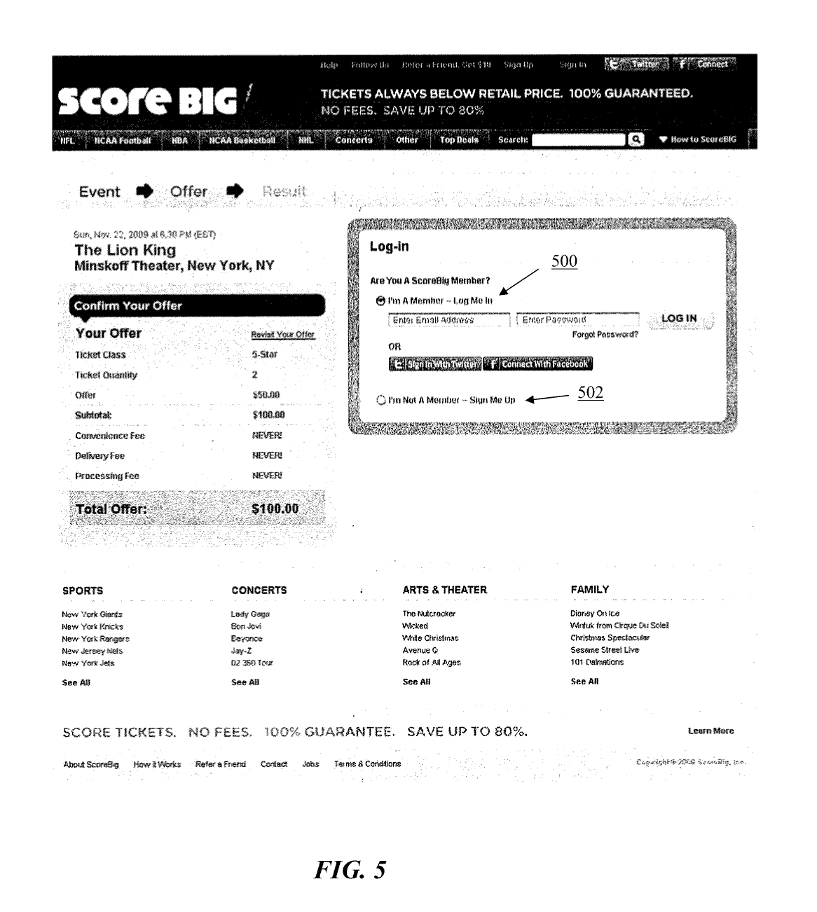

Referring now to FIG. 5, in some embodiments, when a user visits a site constructed in accordance with the present disclosure, the user may be asked to either sign-in using previously established authentication credentials 500 or to sign up as a new user of the site 502. Although FIG. 5 depicts an embodiment of the system using a username and password scheme for authentication, other forms of authentication may be used including two-factor authentication or challenge-response. As shown, in some embodiments, the user may be asked to sign-in after making a bid offer. In other embodiments, the user may be asked to sign-in prior to making a bid.

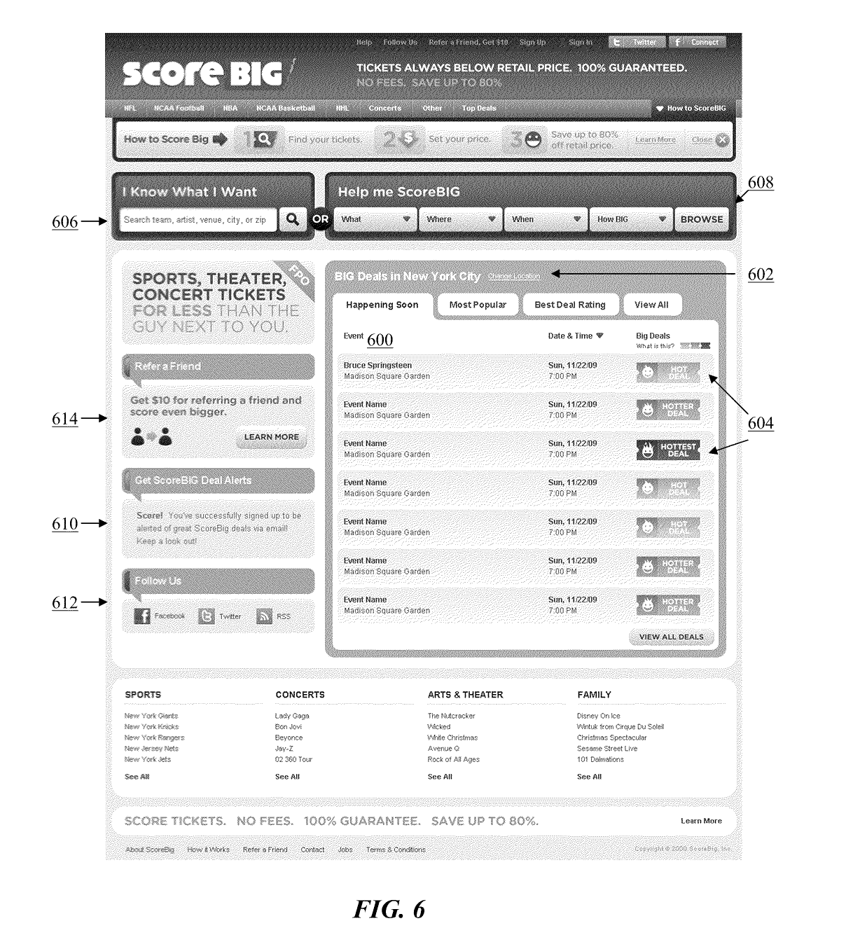

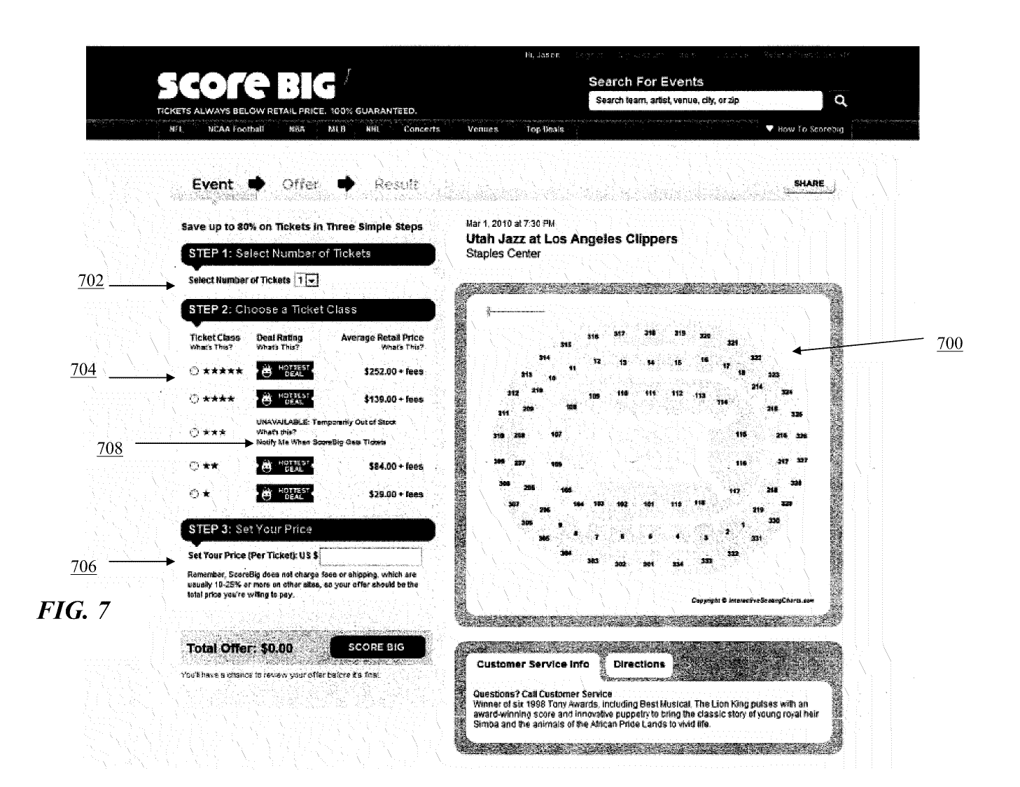

Once authenticated, in some embodiments, the screenshot shown in FIG. 6 may be displayed to the user. In other embodiments, the screenshot depicted in FIG. 6 may be shown to an unauthenticated user. As shown in FIG. 6, the user may be shown a list of events 600 in a certain geographic area 602 having available tickets. As shown in FIG. 6, in some embodiments, events may be classified 604 as “hot deals,” “hotter deals,” or “hottest deals.” Events may be identified in these categories based on the non-user specific dynamic market price being a predetermined amount below the face value of the ticket, the length of time until the event in question, the scarcity of inventory for a particular event, or some combination of these factors.

Still referring to FIG. 6, a user may also be shown a search interface 606. In the embodiment shown in FIG. 6, a user may be presented with the option of specifying a particular event for which to search for tickets (“I Know What I Want”), or the user may have the system provide a selection of available tickets based on certain parameters 608 (“Help me ScoreBIG”). As shown in FIG. 6, the user can specify what kind of event, the physical location of the event, the date and time of the event, and the classification of deal 604 or amount off face value at which a ticket is offered or at which the dynamic market price currently lies. Once those parameters are selected, the system may return one or more available tickets satisfying the parameters specified by the user.

Also as shown in FIG. 6, the user may select the option of being notified of events by email 610, or the user may select the option of having notifications of events pushed to them 612 via Real-Time Syndication (RSS) of through a social networking site such as Twitter or Facebook. The user may also “refer a friend” 614 to the site.

FIG. 7 depicts an embodiment of a screen shot displayed to a user after the selection of an event. As shown in FIG. 7, a visual schematic of the venue 700 is shown to the user identifying sections for seating. The user is also provided a mechanism for identifying the number of tickets desired 702, the quality of tickets desired 704, and the amount the user is willing to pay for each ticket 706. If certain tickets are not available, that fact is indicated to the user 708. In the example shown in FIG. 7, tickets having a “three-star” status are currently unavailable. The user has the option, however, of selecting tickets having one-star, two-star, four-star or five-star status.

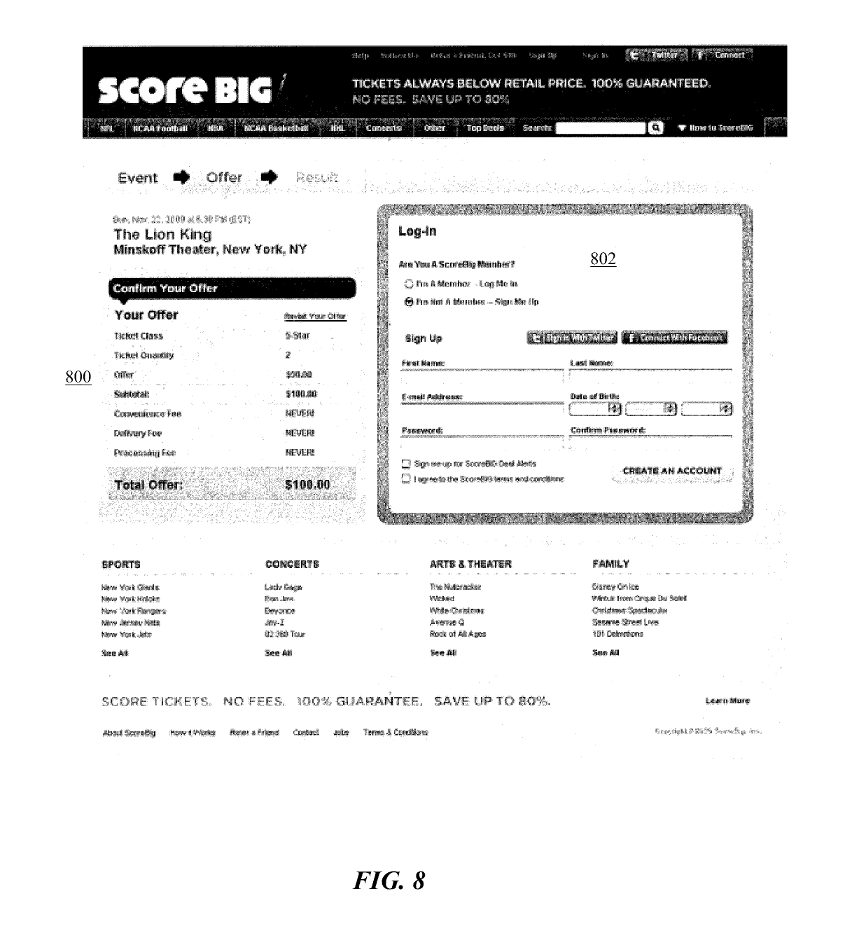

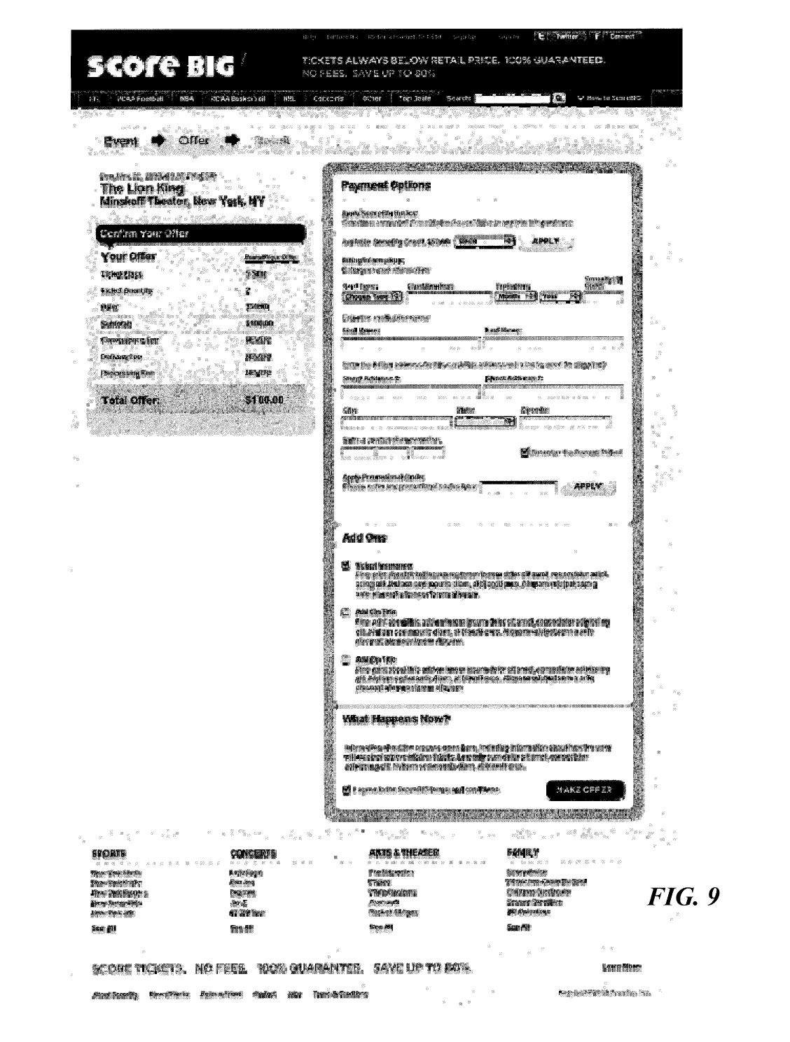

FIG. 8 depicts a screen displayed to the user once an offer has been made by the user. The screen displayed in FIG. 8 seeks the user to confirm the parameters of the offer 800. In the example shown in FIG. 8, the user has offered to pay $50 per ticket for two “five-star” tickets to the see The Lion King at the Minskoff Theater in New York, New York. At this point if the user has not yet identified himself or herself to the system, a portion of the screen 802 will request authentication credentials or invite the user to provide new authentication credentials. FIG. 9 depicts a confirmation screen displayed to a user for whom payment information has not yet been received.

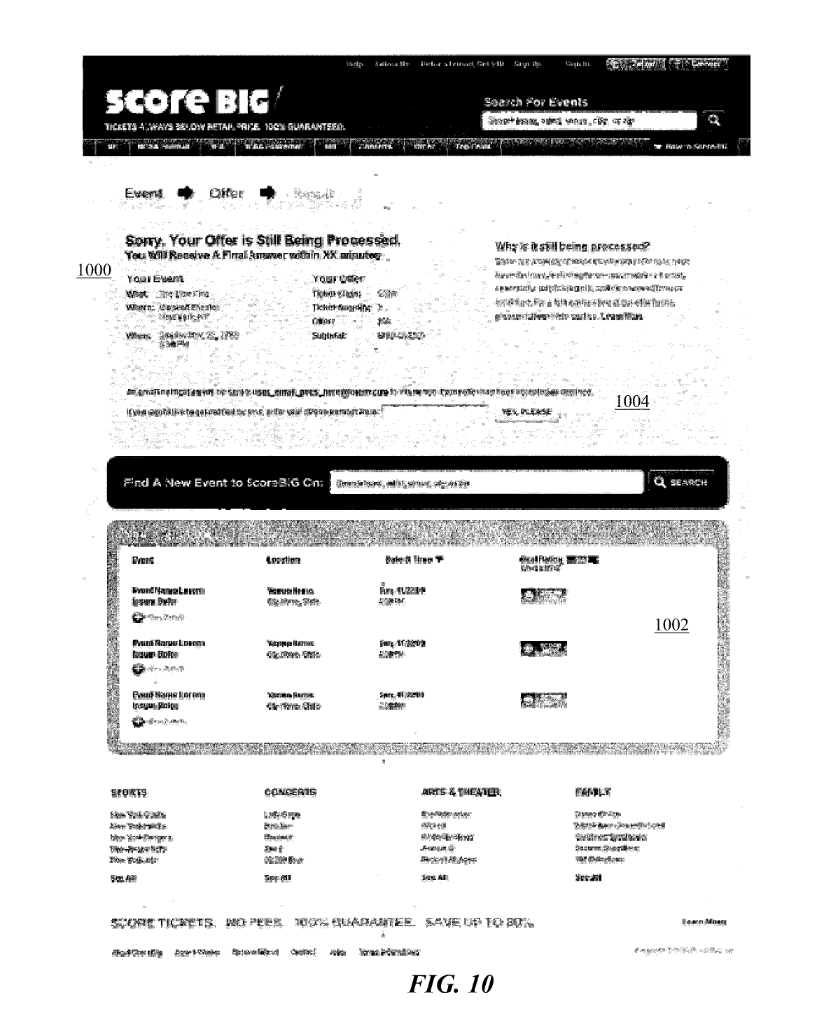

FIG. 10 depicts a screen displayed to the user if processing the user's offer takes more than a few moments. As shown in FIG. 10, the details of the user's offer may repeated 1000. Also, as shown in FIG. 10, other events may be “advertised” 1002 to the user during the delay. The user also has the option of being notified 1004 by email or SMS message if the offer is accepted or declined.

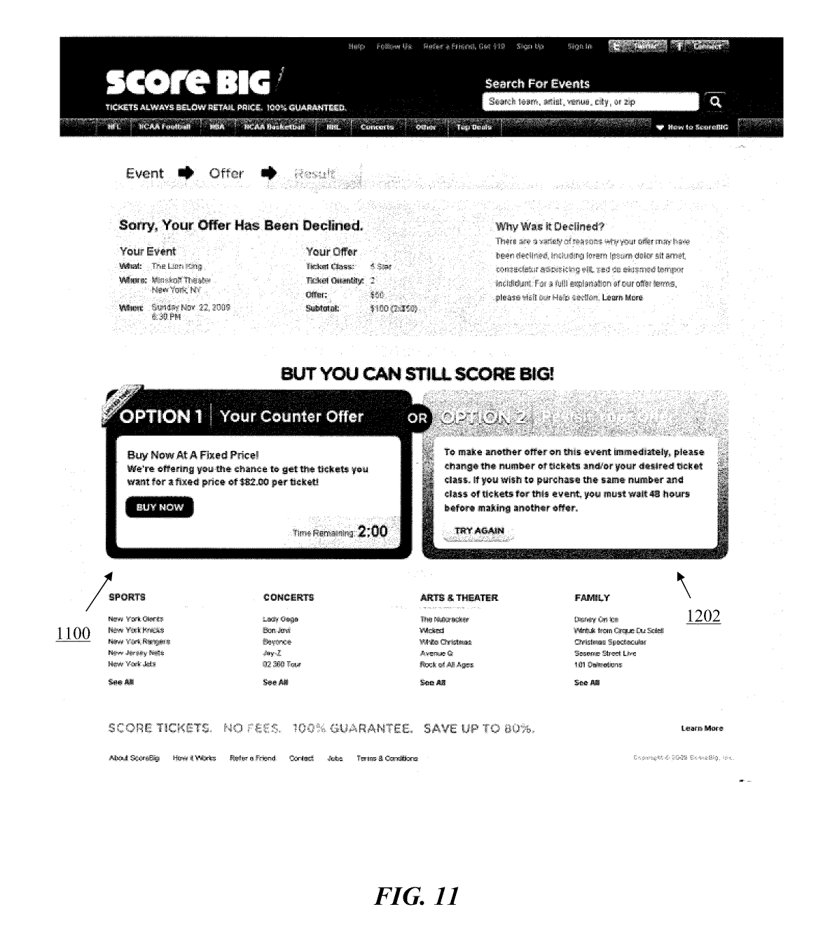

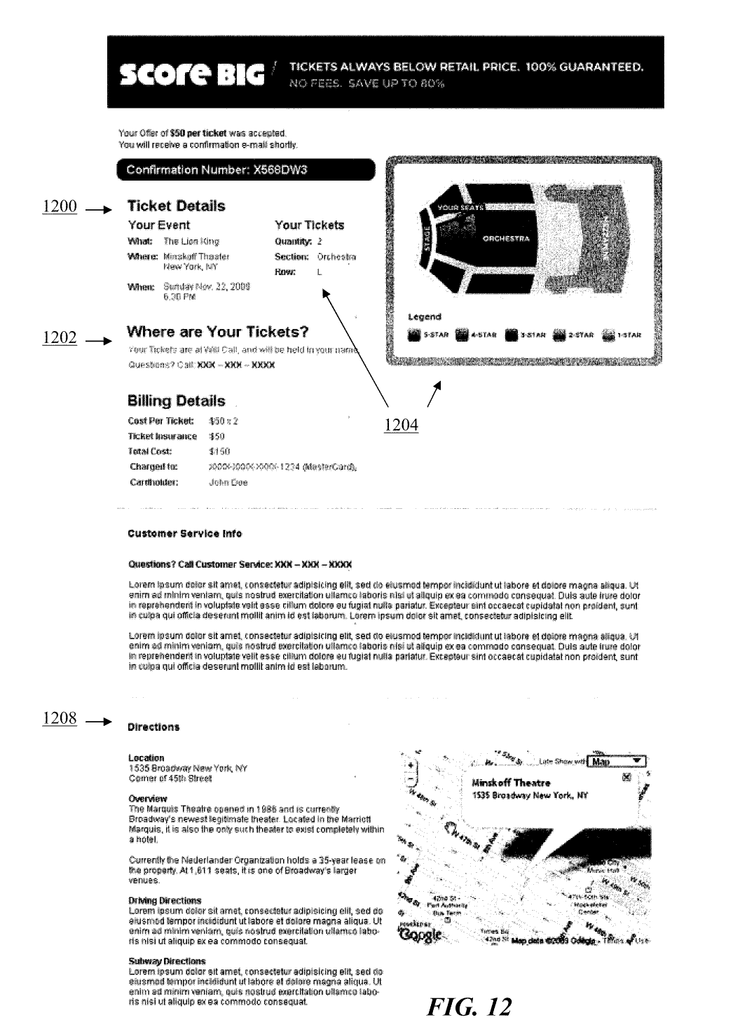

FIGS. 11 and 12 depicts screens displayed to the user if the offer is declined or accepted, respectively. As shown in FIG. 11, if the user's offer is declined, the user is notified of that outcome and given the options of accepting a counter-offer made by the system 1100 or making another offer for tickets to the event 1102. As shown in FIG. 11, if the user elects to make another offer for tickets, the user must change the class of ticket required. Otherwise, the user must wait 24 hours to submit a new offer for the same number of tickets in the same ticket class as that just requested. This may be done to prevent the user from making the same offer repeatedly until a dynamic market price falls to a level at which the offer is accepted.

As shown in FIG. 12, a successful offer may display ticket details 1200, billing details 1202, a visual indication of the general location of the tickets 1204, and details on how the user is to take possession of the purchased tickets 1206. Other information may also be provided to the user at this point in the process. For example, as shown in FIG. 12, directions to the theater 1208 may be included. Other types of information may include hotel and restaurant information or parking information.

As discussed above, whether or not an offer is accepted by the ticketing system may depend on any one of a number of factors, including historical pricing patterns, bid and resale prices, the amount of time until the event, the inventory of tickets for the event still in circulation, whether the buyer is using the system for the first time, whether the system desires to “win back” the user, whether the user presents a churn risk, whether there is risk of revenue erosion or cannibalization, whether an up-sell opportunity exists.

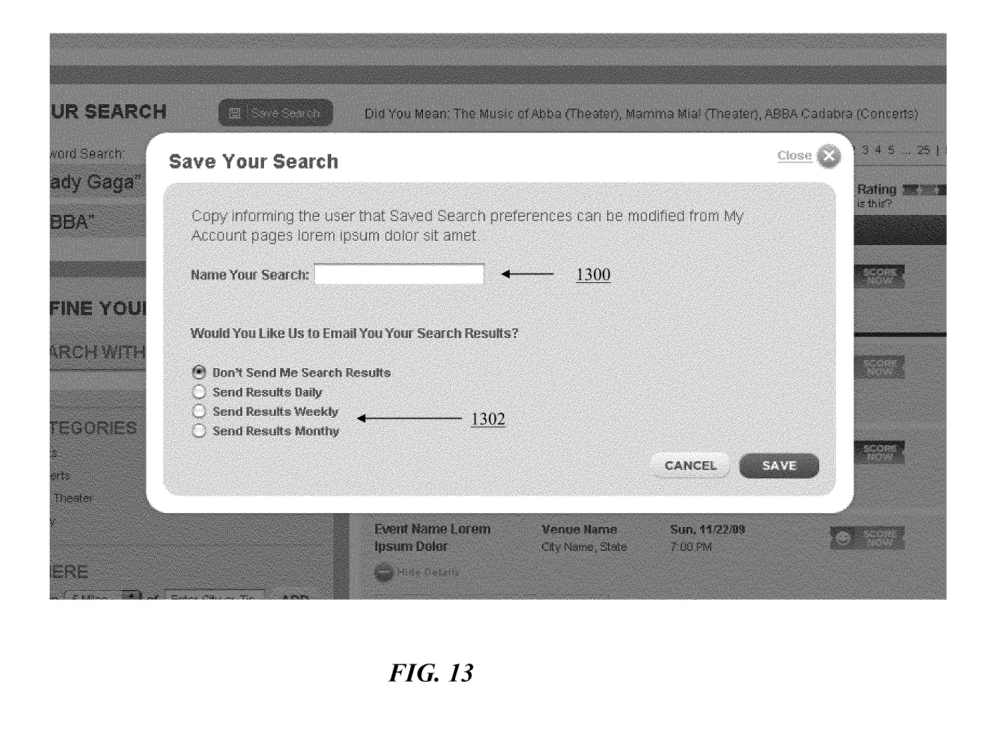

Referring now to FIG. 13, in some embodiments, a search for an item or event performed by a user may be saved. The user may provide a name or nickname for the search 1300, and may select for the search to be repeated periodically 1302. In some embodiments, the user may only save a search after having signed in. In other embodiments, if the user has not signed in and attempts to save a search, the user may be prompted to sign in.

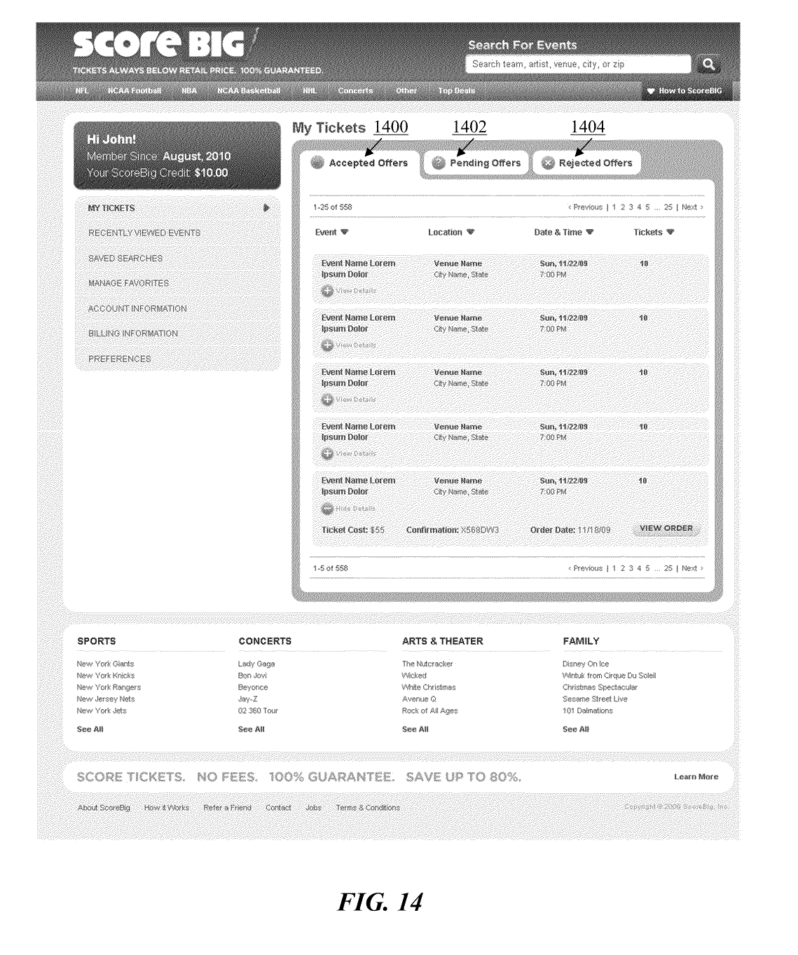

As shown in FIG. 14, in some embodiments, a signed in user may be shown a screen indicating accepted offers 1400, pending offers 1402, and rejected offers 1404. In some embodiments, details shown may comprise information stored in a historical bid record associated with the user.

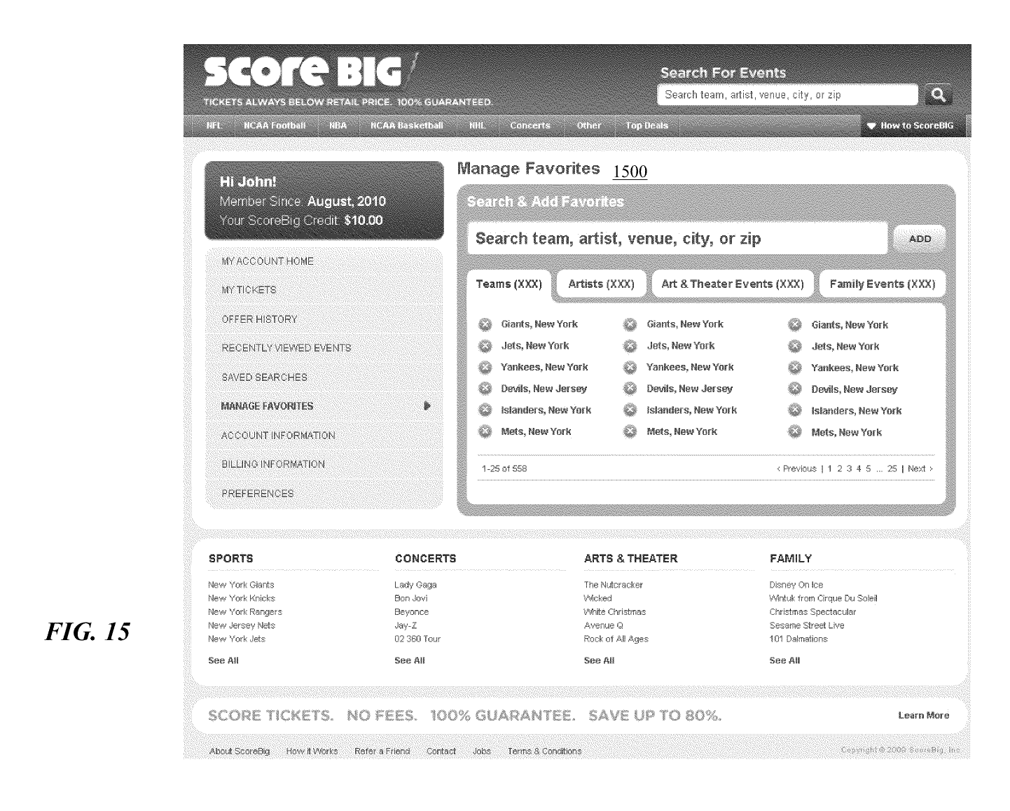

FIG. 15 shows a screenshot of an embodiment in which the user may specify one or more favorites 1500. In some embodiments, when a user has specified a favorite, the system may periodically search for new inventory corresponding to the favorite and notify the user via email or other method.

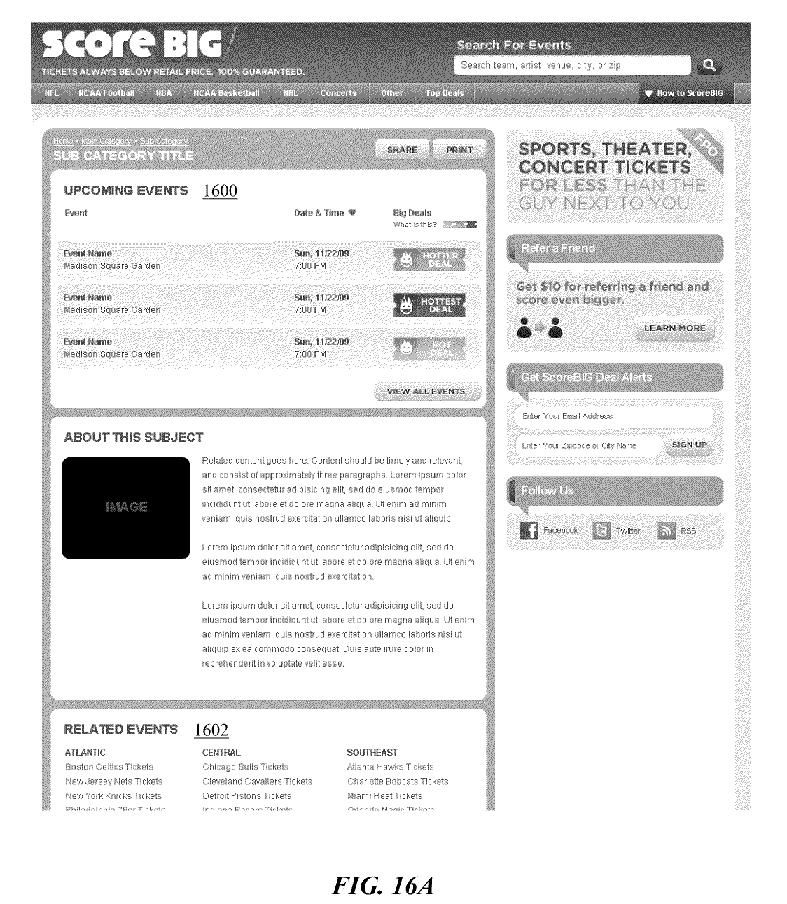

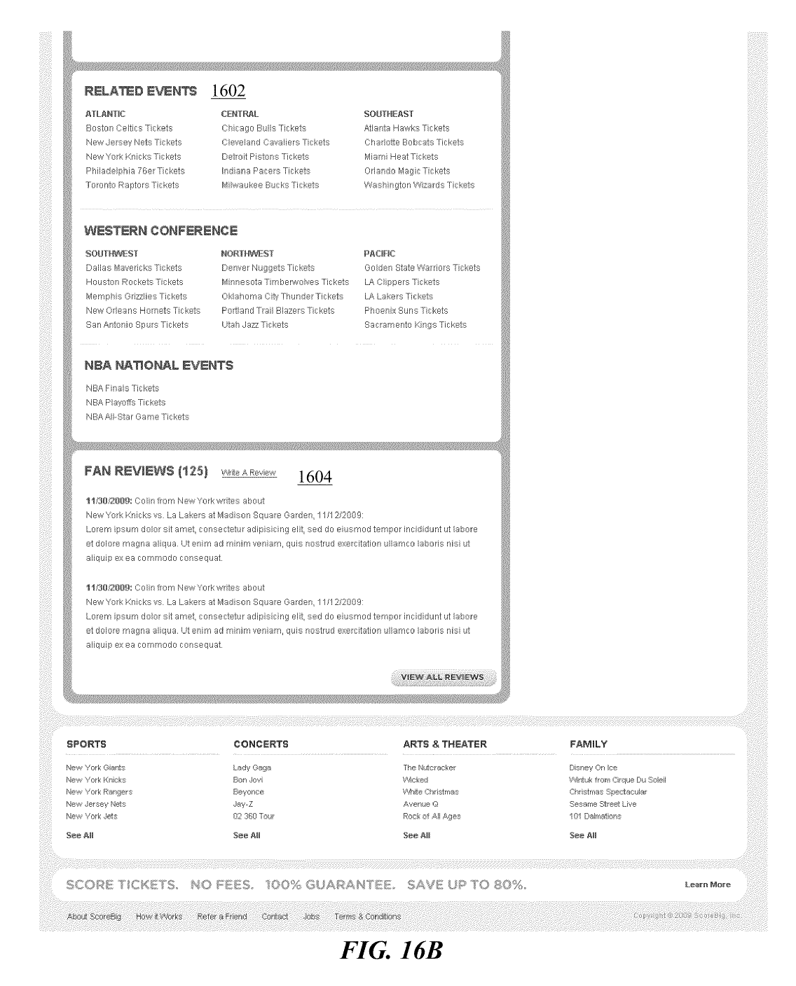

As shown in the screenshot split between FIG. 16A and 16B due to size, in some embodiments, a list of upcoming events 1600 may be provided to a user. In some embodiments, the list of upcoming events 1600 may be sorted into a sub-category, such as upcoming NBA Basketball events, or upcoming events at a venue such as Madison Square garden. This may be useful for users planning a weekend outing, for example. The user may also be shown a list of related events 1602, such as similar events in the same sub-category, as well as reviews entered by other users 1604. In many embodiments, the user may also have the ability to write a review to be seen by other users.

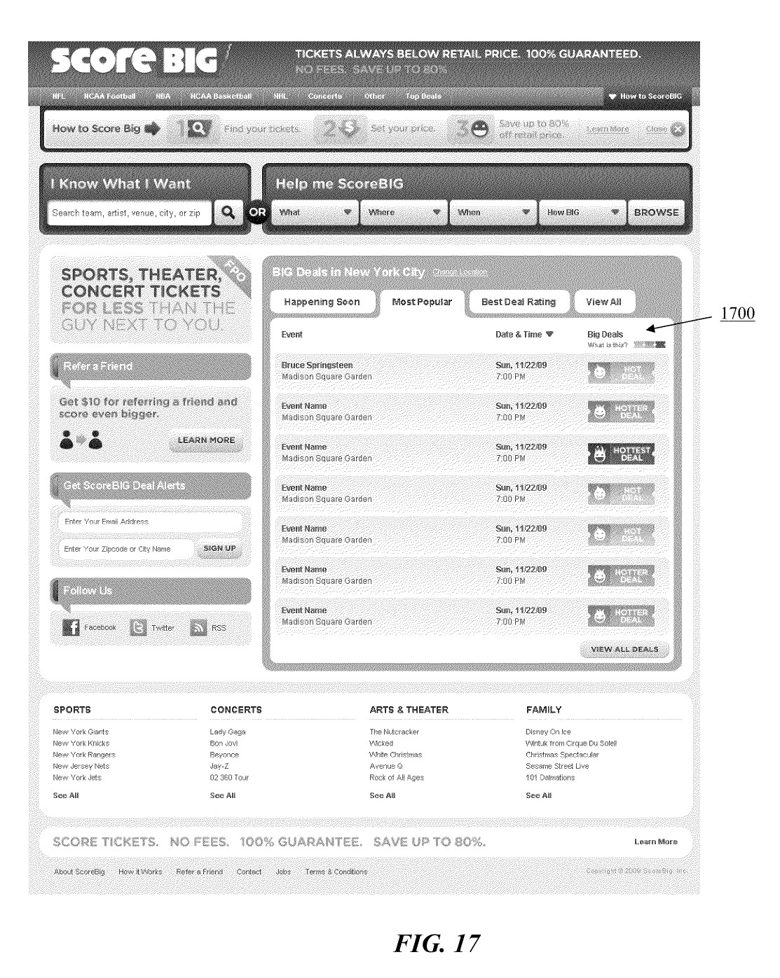

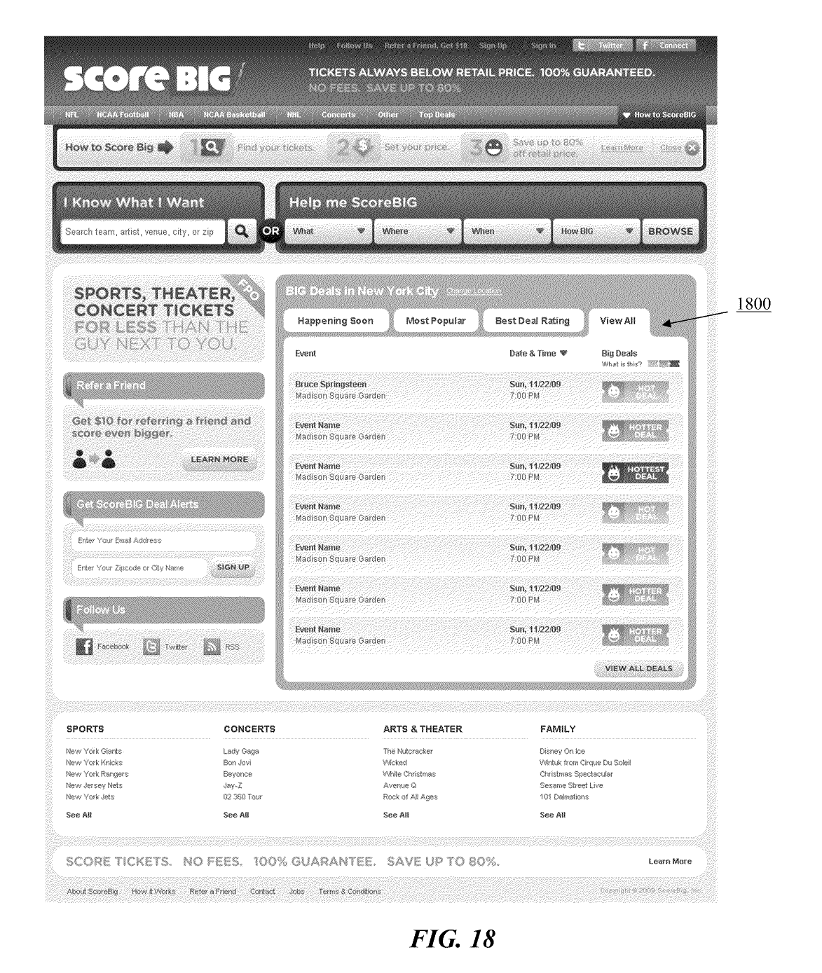

FIG. 17 shows an embodiment in which a user may be shown a list of the most popular upcoming events in a geographic area 1700. Events may be sorted by popularity, deal rating, or nearest date and time. In another embodiment shown in FIG. 18, the user may be shown all events in a geographic area 1800.

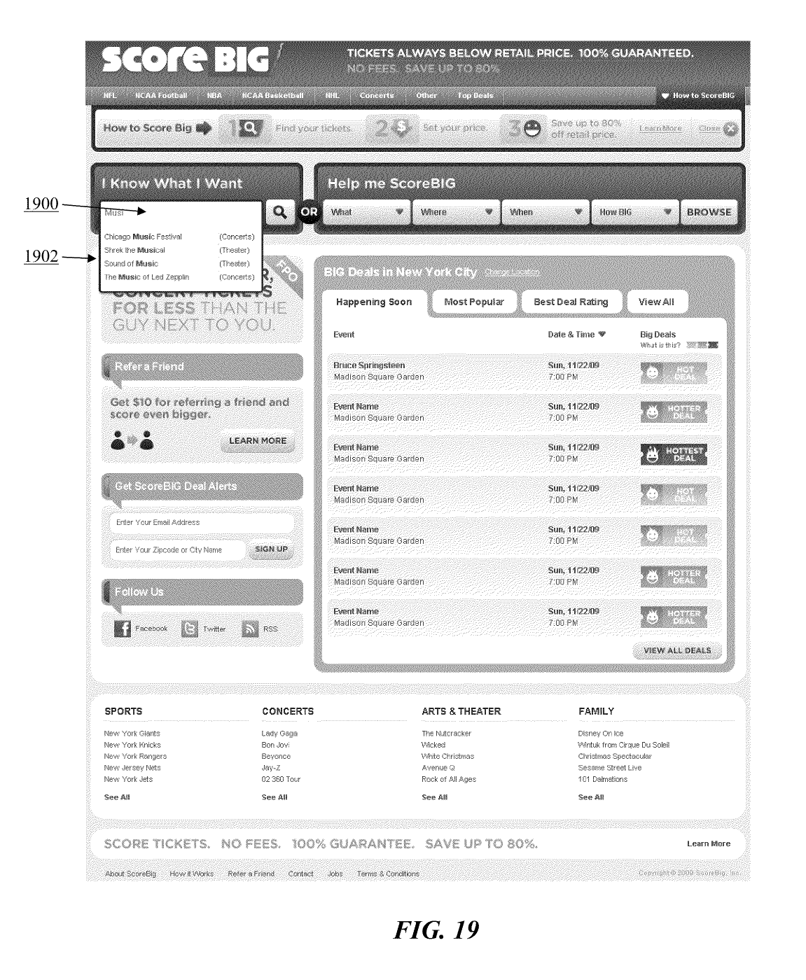

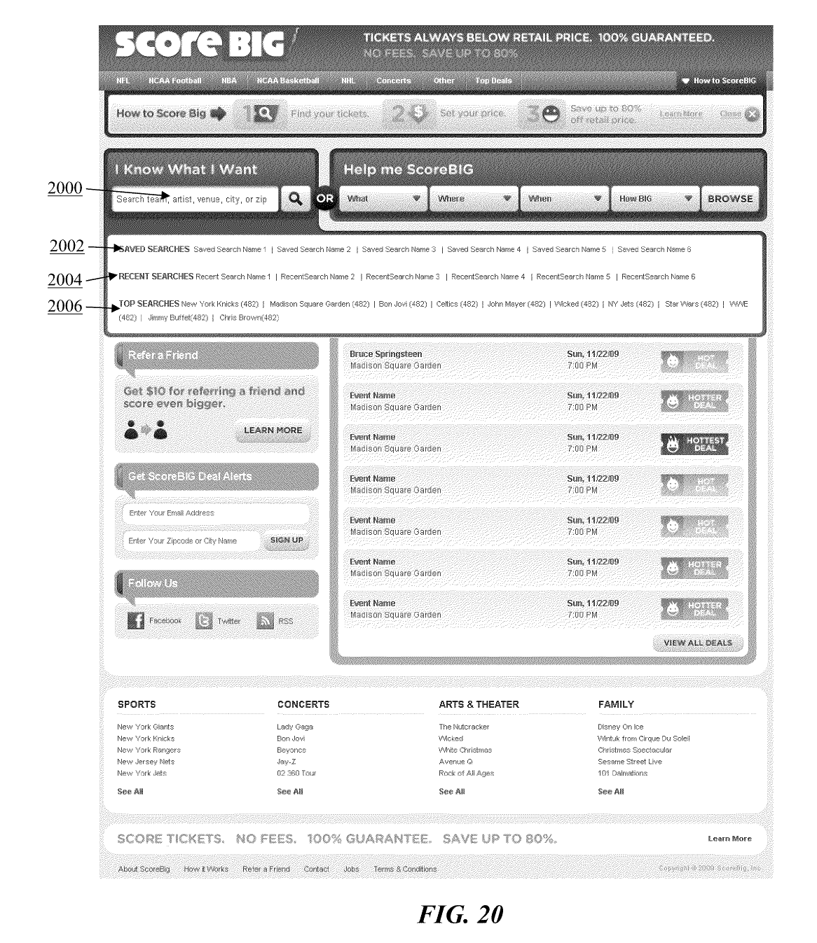

To aid a user searching for events or items, in one embodiment shown in FIG. 19, a user selecting or typing in a search box 1900 may be presented with one or more auto-complete options 1902. In another embodiment shown in FIG. 20, a user selecting a search box 2000 may be shown a list of additional saved searches 2002, recent searches 2004, and top searches of all users of the system 2006. In many embodiments, the list may be presented responsive to a user clicking in the search box 2000.

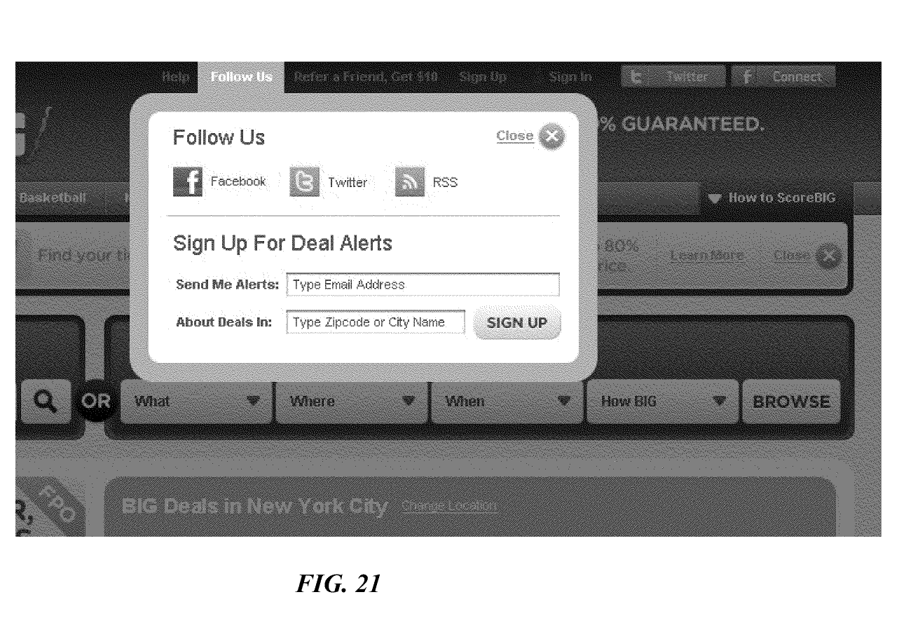

In some embodiments, as shown in FIG. 21, a user may sign up for deal alerts, for example by zip code or city name as shown or via other criteria, to be delivered via email or other means. In other embodiments, the user may subscribe to an RSS feed, Twitter feed, Facebook page, or other social networking site that is updated as new inventory is added to the system.

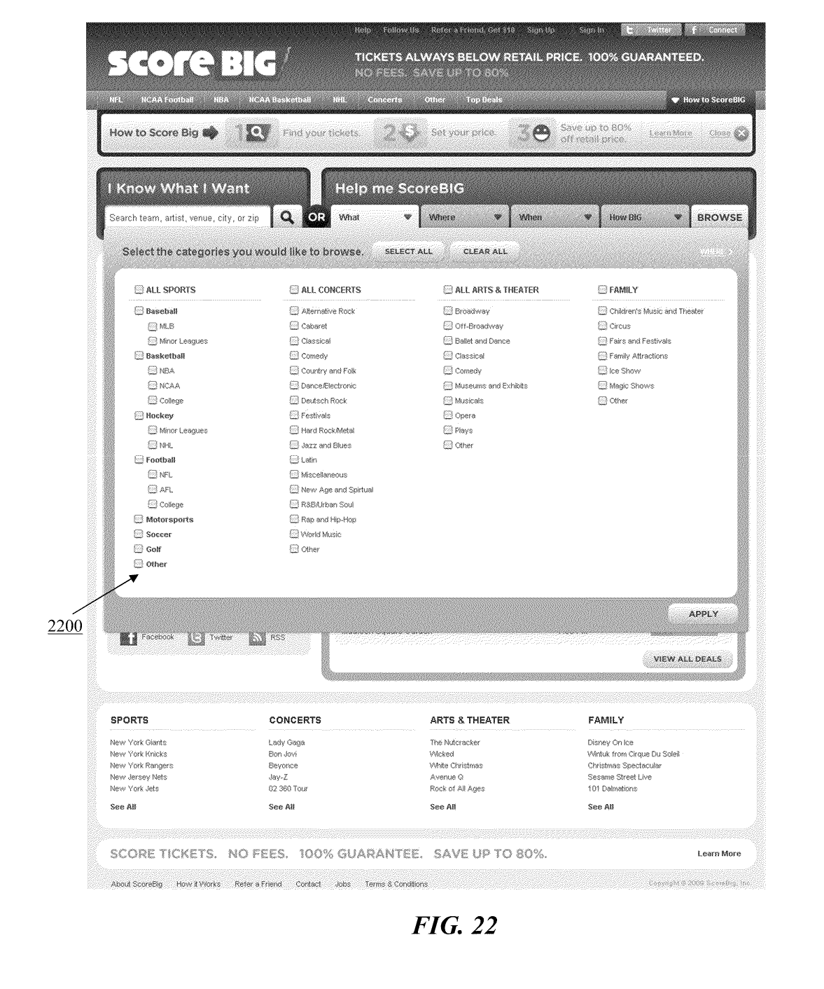

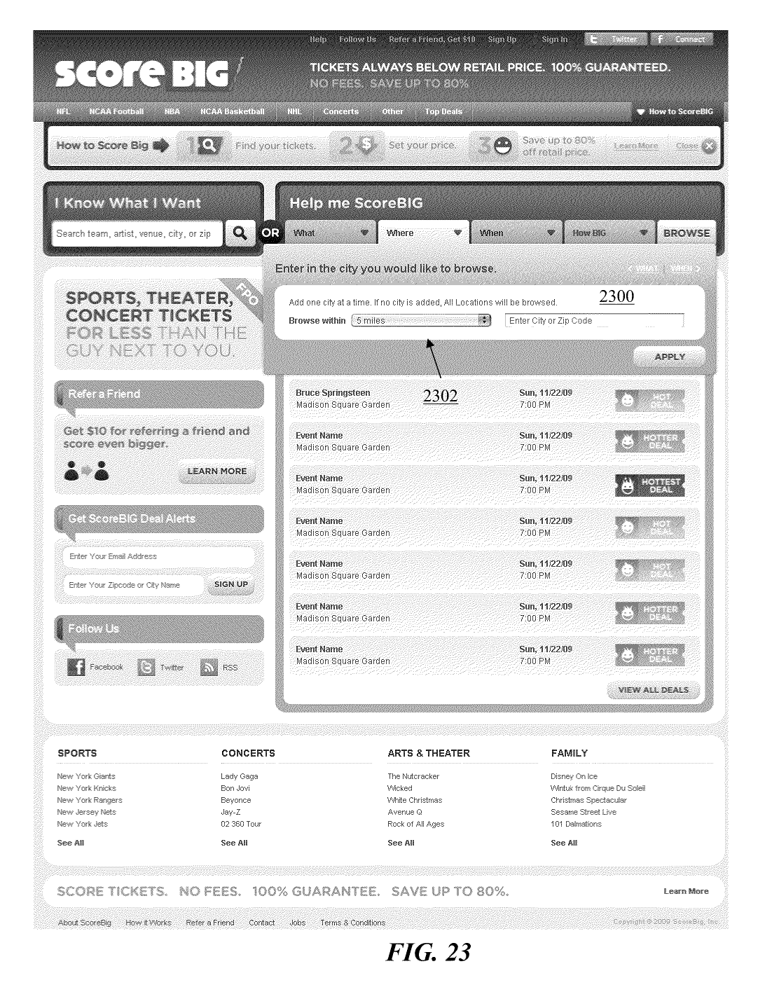

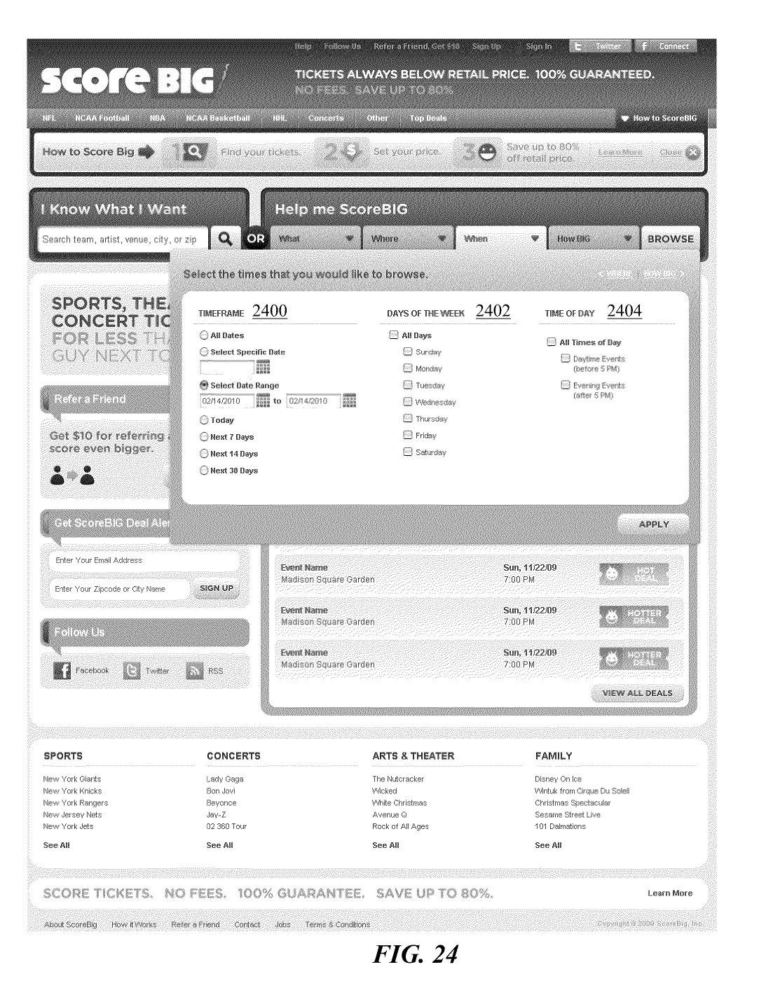

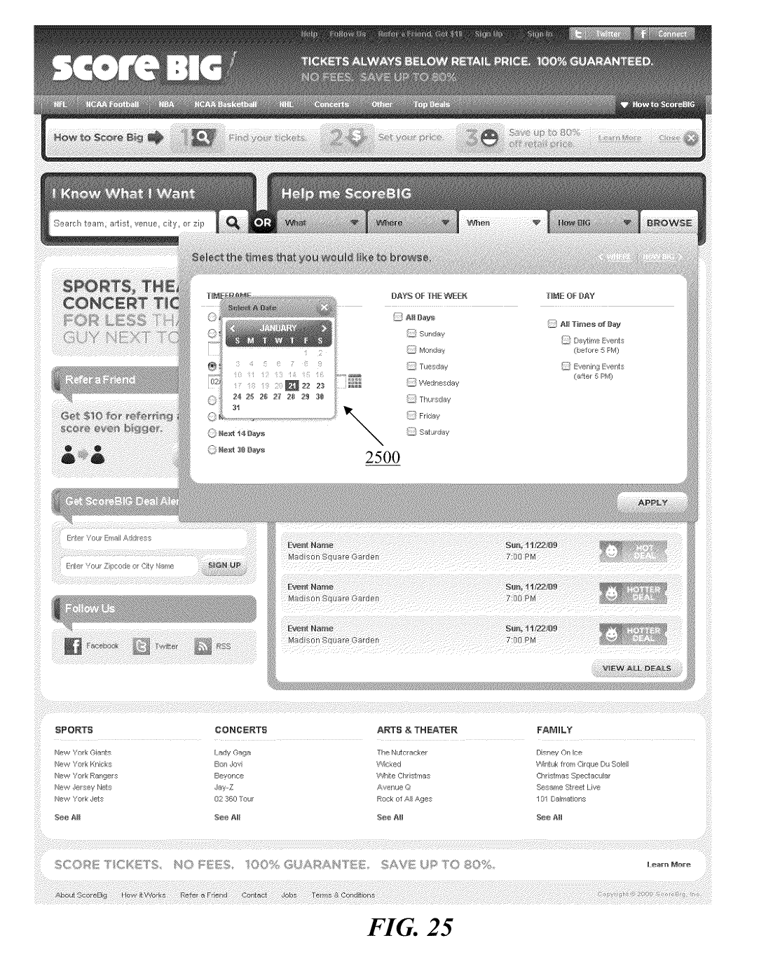

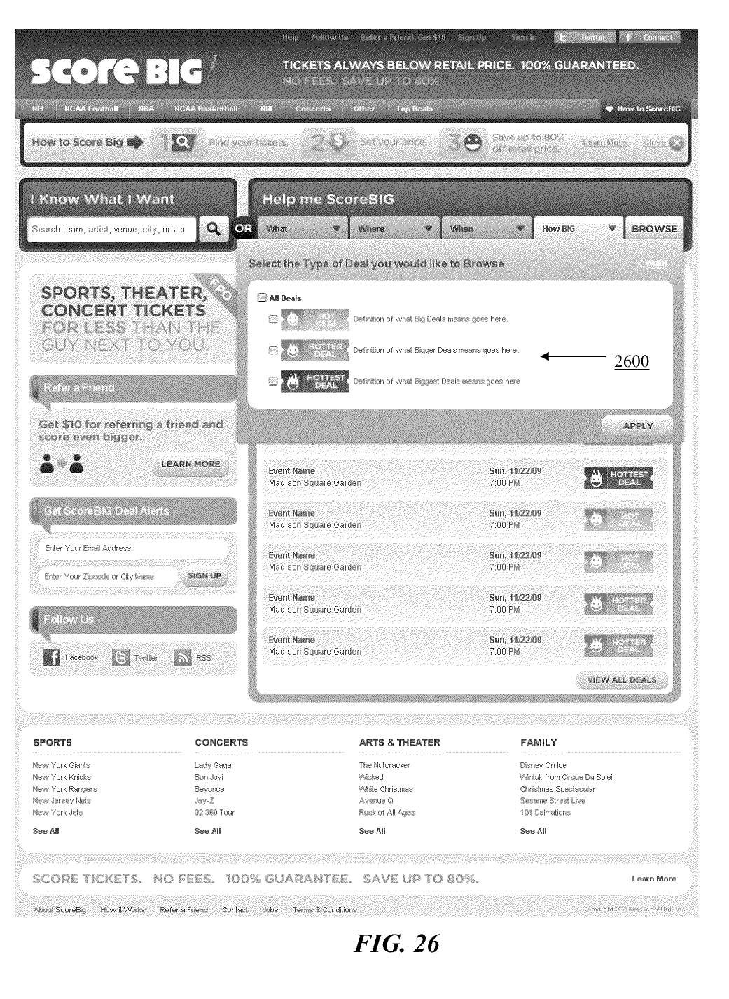

When a user does not want to search by name, but instead browse for events using filters, the user may select one or more criteria to filter from a set of all events. In the embodiment shown in FIG. 22, a user may select one or more categories 2200 to browse. In the embodiment shown in FIG. 23, the user may a city to browse events in by name or zip code 2300 and select a radius 2302. As shown, if no city is selected, then no filter may be applied in some embodiments and events in all cities matching other filters may be shown. As shown in the embodiment of FIG. 24, the user may select a time filter or filters to apply, including date 2400, day of the week 2402, and/or time of day 2404. In a further embodiment shown in FIG. 25, responsive to the user clicking on a date or date range entry field, the interface may display a calendar 2500 to allow the user to select a date. In the embodiment shown in FIG. 26, the user may select a filter to be applied based on the amount 2600 that a current dynamic market price is below a face value or default retail value of the ticket.

Similar filters may be used in other embodiments in which the inventory is not tickets for an event. For example, filters of airline carriers, source and destination cities, and non-stop or multi-stop may be used where the inventory is plane tickets. Filters of new and used may be used where the inventory is books. One skilled in the art may readily appreciate how similar filters may be used in any instance where items of inventory may be grouped into categories and sub-categories.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed:

1. A method for accepting offer bids with a dynamically-adjusted market price, comprising:
receiving, by a first computing device, an offer from a user to purchase at least one item, the offer specifying a first offer price;
adjusting, by a dynamic pricing engine executing on the first computing device, a market price for the at least one item using a user-specific price adjustment; and
determining, by the dynamic pricing engine, that the adjusted market price is less than or equal to the first offer price; and
accepting the offer to purchase the item, responsive to the determination.

2. The method of claim 1, wherein the at least one item is a seating ticket for an event.

3. The method of claim 1, wherein the market price corresponds to a default retail price or face value price for the at least one item set by a provider of the at least one item.

4. The method of claim 1, wherein adjusting the market price is performed responsive to one or more characteristics of the user.

5. The method of claim 1, wherein adjusting the market price is performed responsive to an offer history of the user.

6. The method of claim 1, wherein adjusting the market price comprises decreasing the market price by a first predetermined value, responsive to identifying the user as a new user.

7. The method of claim 1, wherein adjusting the market price comprises decreasing the market price by a second predetermined value, responsive to identifying the user as a returning user and determining the user has not placed an offer bid within a first predetermined time period.

8. The method of claim 1, wherein adjusting the market price comprises decreasing the market price by a third predetermined value, responsive to identifying the user as matching an advertising target criteria for the at least one item; and further comprising providing to the user an offer to purchase a second item corresponding to the advertising target criteria.

9. The method of claim 1, wherein adjusting the market price comprises decreasing the market price by a fourth predetermined value, responsive to determining the user has placed a number of bids for the at least one item within a second predetermined time period, wherein at least a first predetermined percentage of the number of bids have been declined by the dynamic pricing engine.

10. The method of claim 1, wherein adjusting the market price comprises increasing the market price by a fifth predetermined value, responsive to determining the user has placed a number of bids for the at least one item within a third predetermined time period, wherein at least a second predetermined percentage of the number of bids have been accepted by the first computing device.

11. A system for accepting offer bids with a dynamically-adjusted market price, comprising:
a first computing device, configured to receive an offer from a user to purchase at least one item, the offer specifying a first offer price; and
a dynamic pricing engine executing on the first computing device, configured to:
adjust a market price for the at least one item using a user-specific price adjustment, and
determine that the adjusted market price is less than or equal to the first offer price; and
wherein the first computing device is further configured to accept the offer to purchase the item, responsive to the determination.

12. The system of claim 11, wherein the at least one item is a seating ticket for an event.

13. The system of claim 11, wherein the market price corresponds to a default retail price or face value price for the at least one item set by a provider of the at least one item.

14. The system of claim 11, wherein the dynamic pricing engine is further configured to adjust the market price responsive to one or more characteristics of the user.

15. The system of claim 11, wherein the dynamic pricing engine is further configured to adjust the market price responsive to an offer history of the user.

16. The system of claim 11, wherein the dynamic pricing engine is further configured to decrease the market price by a first predetermined value, responsive to identifying the user as a new user.

17. The system of claim 11, wherein the dynamic pricing engine is further configured to decrease the market price by a second predetermined value, responsive to identifying the user as a returning user and determining the user has not placed an offer bid within a first predetermined time period.

18. The system of claim 11, wherein the dynamic pricing engine is further configured to decrease the market price by a third predetermined value, responsive to identifying the user as matching an advertising target criteria for the at least one item; and further comprising providing to the user an offer to purchase a second item corresponding to the advertising target criteria.

19. The system of claim 11, wherein the dynamic pricing engine is further configured to decrease the market price by a fourth predetermined value, responsive to determining the user has placed a number of bids for the at least one item within a second predetermined time period, wherein at least a first predetermined percentage of the number of bids have been declined by the dynamic pricing engine.

20. The system of claim 11, wherein the dynamic pricing engine is further configured to increase the market price by a fifth predetermined value, responsive to determining the user has placed a number of bids for the at least one item exceeding a within a third predetermined time period, wherein at least a second predetermined percentage of the number of bids have been accepted by the first computing device.
